(19) United States
(12) Patent Application Publication
(10) Pub. No.: US 2024/0403971 A1
(43) Pub. Date: Dec. 5, 2024

(54) Predicting Climate Event Occurrences and Damage Using Property Features and Artificial Intelligence

(71) Applicant: Zesty.ai, Inc., Oakland, CA (US)

(72) Inventors: Kumar Dhuvur, Pleasanton, CA (US); Attila Toth, Piedmont, CA (US); Michael Ulin, Portland, OR (US)

(21) Appl. No.: 18/805,393

(22) Filed: Aug. 14, 2024

Related U.S. Application Data
(63) Continuation of application No. 17/402,066, filed on Aug. 13, 2021, now abandoned.
(60) Provisional application No. 63/065,398, filed on Aug. 13, 2020.

(51) Int. Cl. G06Q 40/08; G06Q 50/163

(52) U.S. Cl. CPC G06Q 40/08; G06Q 50/163

(57) ABSTRACT

The disclosure includes a system and method for generating, using one or more processors, a user interface, wherein the user interface includes: a first portion associated with a location of a property of interest input by a user; a second portion associated with an image of the property of interest; a third portion associated with a climate event incidence score representing a relative probability of a first type of climate event occurring at the property of interest; a fourth portion associated with a climate event damage score representing a relative severity of damage to the property of interest were the first type of climate event to occur at the property of interest; and sending, using one or more processors, the user interface for presentation to the user.

### CROSS-REFERENCE TO RELATED APPLICATIONS

The present application claims priority to U.S. application Ser. No. 17/402,066, filed Aug. 13, 2021, titled “Determining Climate Risk Using Artificial Intelligence” and to U.S. Provisional Application No. 63/065,398, filed Aug. 13, 2020, titled “Determining Climate Risk Using Artificial Intelligence,” the entireties of which are hereby incorporated by reference.

### FIELD OF DISCLOSURE

The present disclosure relates generally to systems and methods for determining climate events using artificial intelligence. In particular, the present disclosure relates to systems and methods for determining likelihood and property damage from various climate events. Still more particularly, the present disclosure relates to systems and methods that use artificial intelligence to determine occurrences from various climate events, such as wildfire, flood, and severe convective storms (e.g., hail), lightning, tornado, hurricane, etc., and/or whether the occurrences are likely to be damaging.

Climate events, such as wildfire, flood, and severe convective storms (e.g., hail), lightning, tornado, hurricane, etc., cause damage. However, there are no ways accurately predicting the chance of a climate event to a property or a damaging climate event, much less ways to accurately account the property-specific attributes of that property.

### SUMMARY

This specification relates to methods and systems for predicting climate events using artificial intelligence. In general, an innovative aspect of the subject matter described in this disclosure may be implemented in methods that include: generating, using one or more processors, a user interface, wherein the user interface includes: a first portion associated with a location of a property of interest input by a user; a second portion associated with an image of the property of interest; a third portion associated with a climate event incidence score representing a relative probability of a first type of climate event occurring at the property of interest; a fourth portion associated with a climate event damage score representing a relative severity of damage to the property of interest were the first type of climate event to occur at the property of interest; and sending, using one or more processors, the user interface for presentation to the user.

Other implementations of one or more of these aspects include corresponding systems, apparatus, and computer programs, configured to perform the actions of the methods, encoded on computer storage devices.

These and other implementations may each optionally include one or more of the following features. For example, the features may include that the third portion includes one or more sub-portions indicating a first set of top features associated with the property of interest, where the first set of top features include a first set of features associated with the property of interest with a greatest relative impact on the climate event incidence score. For example, the features may include that the fourth portion includes one or more sub-portions indicating a second set of top features associated with the property of interest, where the second set of top features include a second set of features associated with the property of interest with a greatest relative impact on the climate event damage score. For example, the features may include that the user interface further may include one or more of: a fifth portion associated with a confidence level; and a sixth portion associated with one or more remedial actions that, when performed, may affect one or more of the climate event incidence score and the climate event damage score. For example, the features may include that the property data includes image data associated with the property of interest; determining, using a first climate associated with the first type of climate event, the climate event incidence score associated with the property; and determining, using a second climate, the climate event damage score associated with the property of interest. For example, the features may include training the first climate based at least in part on the one or more features associated with the plurality of properties; and validating the first climate based on one or more of a geographic location hold-out and a temporal hold-out, where the geographic location hold-out held out a geographic location including a location associated with the property. For example, the features may include that the validation of the first climate is based on the temporal hold-out, the method may include: determining whether the first climate is predictive of held-out data associated with a first time period of time, where the first climate is trained on a second time period distinct from the first time period associated with the held-out data; iteratively training and validating the first climate with different temporal hold-outs to determine, based on an accuracy of the first climate: a minimum period of most recent training data; and a maximum period of most recent training data, where one or more of the minimum period and the maximum period of most recent training data are associated with a pattern change. For example, the features may include that a set of validation metrics is used to validate against a held-out population, the set of validation metrics including one or more of: a sum of a target divided by a sum observed by the first climate; an f1 score; and a receiver operating characteristic, where the f1 score and the receiver operating characteristic are indicative of an ability of the first climate to discriminate between areas likely to have an incident of the first climate event or not; and where the first climate is adapted based on a bias associated with the first climate. For example, the features may include that the property image data associated with the plurality of properties includes images associated with the plurality of the properties visually representing at least a subset of the plurality of properties before and after a prior incident of the first climate event; automatically extracting, using computer vision, one or more features associated with the plurality of properties; and training the second climate, where training the second climate is based at least in part on the one or more features associated with the plurality of properties; and validating the second climate based on one or more of a geographic location hold-out and a temporal hold-out, where the geographic location hold-out held out a geographic location including a location associated with the property. For example, the features may include that the validation is based on the temporal hold-out and further may include one or more of: determining whether the second climate is predictive of held-out data associated with a first time period of time, where the second climate is trained on a second time period distinct from the first time period associated with the held-out data; and iteratively training and validating the second climate with different temporal hold-outs to determine, based on an accuracy of the second climate: a minimum period of most recent training data; and a maximum period of most recent training data, where one or more of the minimum period and the maximum period of most recent training data are associated with a pattern change. For example, the features may include that a set of validation metrics including one or more of: a sum of a target divided by a sum observed by the second climate; an f1 score; and a receiver operating characteristic, where the f1 score and the receiver operating characteristic are indicative of an ability of the second climate to discriminate between structures likely to be damaged or not, and where the second climate is adapted based on a bias associated with the second climate. For example, the features may include that the first climate event is one of a wildfire, a flood, hail, lightning, tornado, hurricane, drought, and wind. For example, the features may include that the first climate event includes wildfire; the first climate is a climate event incident model, the second climate is a climate event damage model; the climate event incidence score representing a likelihood of wildfire occurring at the location of the property; the climate event damage score representing a likelihood of damage from wildfire to the property; the incident score is based on a distance or the property to a historic fire perimeter, a distance of the property to an area with high wildfire suppression difficulty, a fuel type associated with the property, a wildfire suppression difficulty associated with the property, a topography associated with the property, an average temperature associated with the property, a distance of the property to a nearest fire station, and an average annual precipitation associated with the property; and the damage score is based on a neighboring vegetation density, a year built, a surrounding vegetation density, a roof material associated with the property, a fuel type, the fuel type associated with the property, an overhanging vegetation density, and a land slope.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of one example system for a climate event predictor in accordance with some implementations.

FIG. 2 is a block diagram of an example server in accordance with some implementations.

FIGS. 3A & B are block diagrams of example climate event predictors in accordance with some implementations.

FIG. 4 is a block diagram of an example climate event engine in accordance with some implementations.

FIG. 5A is a block diagram of an example trainer in accordance with some implementations.

FIG. 5 B is a block diagram of an example incident trainer in accordance with some implementations.

FIG. 5 C is a block diagram of an example damage trainer in accordance with some implementations.

FIG. 6 is a flowchart of an example method for predicting climate events using artificial intelligence in accordance with some implementations.

FIGS. 7A & B are flowcharts of example methods for training a climate in accordance with some implementations.

FIGS. 8A & B are flowcharts of example methods for using climate(s) on a property to generate a result in accordance with some implementations.

FIGS. 9A & B are a flowchart of an example method for obtaining property data in accordance with some implementations.

FIGS. 10A & B are a flowchart of another example method for obtaining property data in accordance with some implementations.

FIG. 11 is a flowchart of an example method for creating a dataset of structures damaged by a climate event including loss data in accordance with some implementations.

FIG. 12 illustrates an example user interface associated with assessing a climate event in accordance with some implementations.

FIG. 13 illustrates another example user interface associated with assessing a climate event in accordance with some implementations.

### DETAILED DESCRIPTION

The techniques introduced herein overcome the deficiencies and limitations of the prior art at least in part by providing systems and methods for determining climate event(s) using artificial intelligence. The systems and method of the present disclosure create and use climate models to determine the probability that a location/property will be affected by a climate event. The present disclosure also uses the models to determine a occurrence and/or damage from a climate event.

While the present disclosure is described below primarily in the context of a climate event of fire, and secondarily a climate event of hail and flood, the models, systems, and methods of the present disclosure are applicable to any climate event. For example, in other implementations the models, systems, and methods of the present disclosure may be used in a similar way to determine probability of damage and the extent of damage from any climate event including tornadoes, hurricanes or cyclones, blizzards, dust storms, ice storms, earthquakes, lightning, etc., even though the present disclosure is described primarily in the context of fire, hail, and flood below. It should be understood that the models, systems, and methods are modifiable, or adjustable and applicable for any climate event and remain within the scope of the present disclosure.

One particular advantage of the systems and methods of the present disclosure is the use of artificial intelligence or machine learning. While the systems and methods of the present disclosure are described below in the context of some implementations using supervised learning, in particular, a gradient boosted machine, it should be understood that the systems and methods of the present disclosure may be implemented using other machine learning approaches such as but not limited to semi-supervised learning, unsupervised learning, reinforcement learning, topic modeling, dimensionality reduction, meta-learning and deep learning.

The systems and method of the present disclosure has a number advantages over prior art system and methods.

First, systems and method of the present disclosure advantageously use climate models in a particular architecture. The architecture of climate models of the present disclosure includes: a first climate model that provides a score for a location/property that indicates the probability of being involved in a climate event (e.g., a future wildfire); a second climate model that provides a score for a location/property that indicates the probability and/or extent of damage to the property if it is involved in a climate event (e.g., a future wildfire); and a third climate model that provides a view of probability for a collection or portfolio of location/properties. The portfolio view may provide both expected loss metrics (i.e., average) and probable loss metrics (i.e., various percentiles such as 99th percentile, 95th percentile, 90th percentile, 80th percentile etc.).

Second, the systems and methods of the present disclosure advantageously provide both property scores and portfolio models, that adapt and exchange information with each other. In contrast, existing prior art systems are not able to produce both scores, and do not interact and communicate with each other. The prior art either provides property scores or provide portfolio models but not both. The systems and methods of the present disclosure are unique because they provide a consistent view from the property scores to the portfolio models and the portfolio model is built leveraging the property scores.

Third, the systems and methods of the present disclosure advantageously leverages property specific information such as vegetation, buildings materials, etc. to provide a score that measures the probability/extent of damage when the property gets involved in a climate event. In particular, the second climate model, Level 2, uses property specific factors. Therefore, the systems and methods may advantageously identify low risk homes in what are considered high risk areas and/or high-risk homes in low-risk areas. Additionally, the machine learning for the second climate model derives many of these property specific features from imagery.

Fourth, the systems and method of the present disclosure advantageously have portfolio models that use property scores from the first climate model (Level 1) and the second climate model (Level 2) and statistical methods to simulate catastrophic events and associated losses for a portfolio of properties over many years, e.g., thousands of years. In contrast, other prior art systems that do portfolio modeling usually develop the models based on physical/scientific drivers of catastrophic events (e.g., for wildfires they may use wind patterns, causes of wildfire ignition, vegetation affecting spread of wildfires etc.) and they simulate various catastrophic events.

All of these above advantages are achieved by the systems and methods of the present disclosure which include:

Methods for creating property models using statistical methods (e.g., AI/ML) as opposed to physical/scientific methods.

Methods for generating property scores including a score for the probability that a location/property will be affected by a climate event, and a score for a probability of damage/extent of damage from a climate event based on historical event and loss data.

Methods for producing the training data for the property models, i.e., procuring and using loss data for training Level 1 and Level 2 models. The loss data may be accumulated from imagery comparison, from carriers, from research organizations and from roofing companies. For example, for a wildfire climate event, imagery comparison and loss data are used to determine losses. The imagery comparison may be between pre-event imagery and post-event imagery. For a hail climate event, imagery comparison augmented with loss data may be used.

The first climate model and the second climate model including specific variables that go into Level 1 and Level 2 and (optionally) how some of the variables are derived using machine learning from aerial imagery. Additionally, the use of different variables for different climate events, e.g., fire, hail, and flood.

The first climate model and a second climate model including weights (or more precisely the tree structure where the models are GBM) used in Level 1 and Level 2.

### Example System

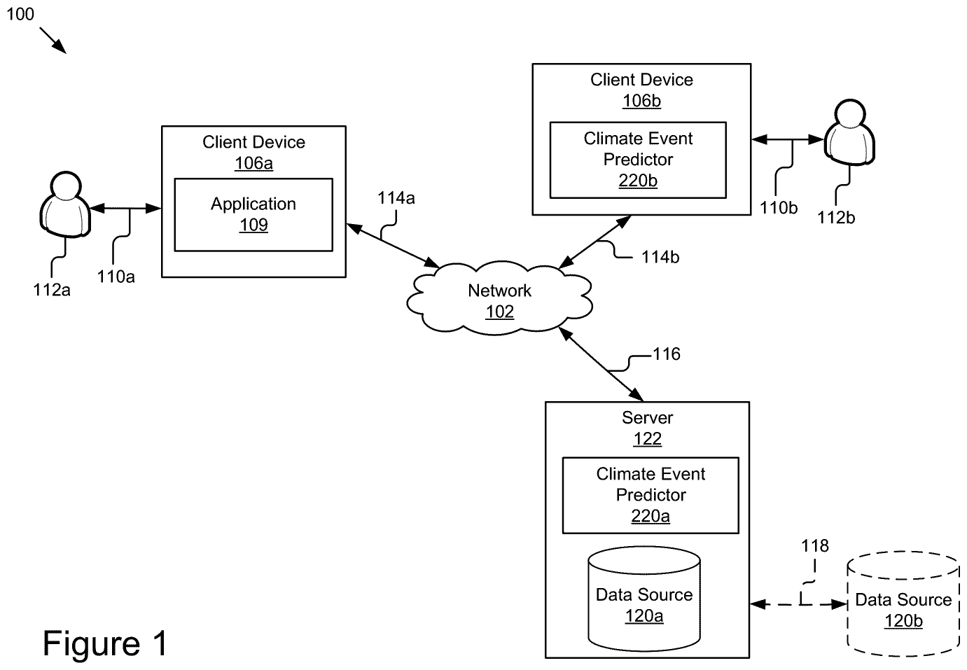

FIG. 1 is a block diagram of one example system for determining climate event using artificial intelligence in accordance with some implementations. As depicted, the system 100 includes a server 122 and client devices 106a and 106b coupled for electronic communication via a network 102. The client devices 106a or 106b may occasionally be referred to herein individually as a client device 106 or collectively as client devices 106. Although two client devices 106 are shown in FIG. 1, it should be understood that there may be any number of client devices 106.

A client device 106 is a computing device that includes a processor, a memory, and network communication capabilities (e.g., a communication unit). The client device 106 is coupled for electronic communication to the network 102 as illustrated by signal line 114. In some implementations, the client device 106 may send and receive data to and from other entities of the system 100 (e.g., a server 122). Examples of client devices 106 may include, but are not limited to, mobile phones (e.g., feature phones, smart phones, etc.), tablets, laptops, desktops, netbooks, portable media players, personal digital assistants, etc.

It should be understood that the system 100 depicted in FIG. 1 is provided by way of example and the system 100 and/or further systems contemplated by this present disclosure may include additional and/or fewer components, may combine components and/or divide one or more of the components into additional components, etc. For example, the system 100 may include any number of client devices 106, networks 102, or servers 122.

In some implementations, the client device 106 includes an application 109. Depending on the implementation, the application may include a dedicated application or a browser (e.g., a web browser, such as Chrome, Firefox, Edge, Explorer, Safari, or Opera). In some implementations, a user 112 accesses the features and functionalities of the climate event predictor 220a/b via the application 109.

The network 102 may be a conventional type, wired and/or wireless, and may have numerous different configurations including a star configuration, token ring configuration, or other configurations. For example, the network 102 may include one or more local area networks (LAN), wide area networks (WAN) (e.g., the Internet), personal area networks (PAN), public networks, private networks, virtual networks, virtual private networks, peer-to-peer networks, near field networks (e.g., Bluetooth®, NFC, etc.), cellular (e.g., 4G or 5G), and/or other interconnected data paths across which multiple devices may communicate.

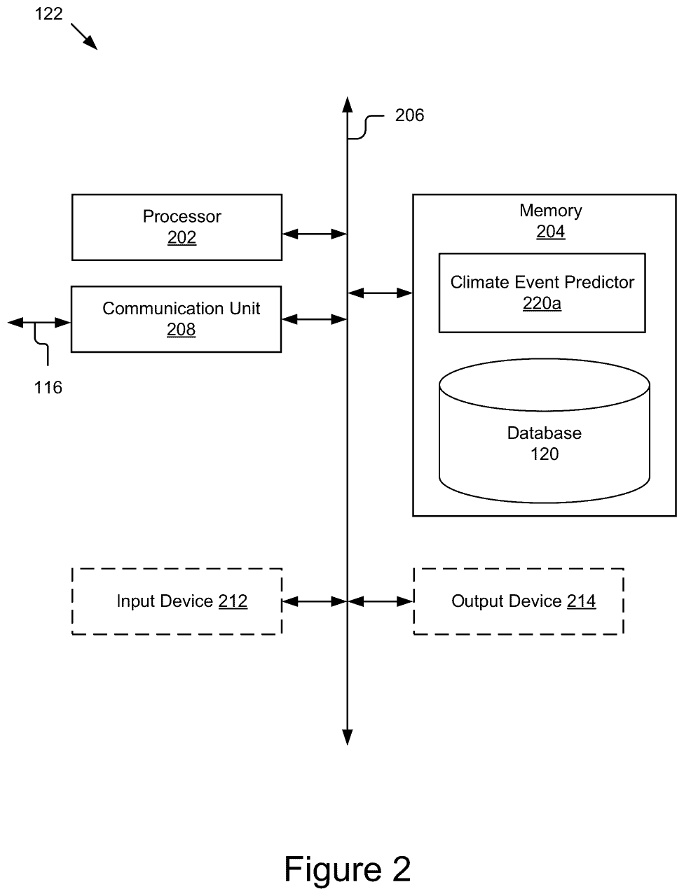

The server 122 is a computing device that includes a hardware and/or virtual server that includes a processor, a memory, and network communication capabilities (e.g., a communication unit). The server 122 may be communicatively coupled to the network 102, as indicated by signal line 116. In some implementations, the server 122 may send and receive data to and from other entities of the system 100 (e.g., one or more client devices 106). Some implementations for the server 122 are described in more detail below with reference to FIG. 2.

Data source 120a is a non-transitory memory that stores data for providing the functionality described herein. The data source 120a/b may include one or more non-transitory computer-readable mediums for storing the data. In some implementations, the data source 120a may be incorporated with the memory of the server 122 or the data source 120b may be distinct from the server 122 and coupled thereto. In some implementations, the data source 120 may be remote from the server 122, as illustrated by instance 120b. For example, in some implementations, (not shown) the data source 120b may include network accessible storage and/or one or more third party data sources that store and maintain data used to provide the functionality described herein.

The data source 120 may be a dynamic random-access memory (DRAM) device, a static random-access memory (SRAM) device, flash memory, or some other memory devices. In some implementations, the data source 120 may include a database management system (DBMS) operable on the server 122. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations. In other implementations, the data source 120a/b also may include a non-volatile memory or similar permanent storage device and media including a hard disk drive, a CD-ROM device, a DVD-ROM device, a DVD-RAM device, a DVD-RW device, a flash memory device, or some other mass storage device for storing information on a more permanent basis.

The data source 120 stores data for providing the functionality described herein. The data may vary based on the implementation and climate event(s) being assessed. Examples of data that the data source 120 may store include, but are not limited to, one or more of image data (e.g., aerial images, satellite images, etc.), damage or loss data, historic climate event data, weather data (e.g., average temperature, average precipitation, etc.), boundary definitions (e.g., flood zones), emergency service locations (e.g., fire department locations), and topographical or other maps.

Other variations and/or combinations are also possible and contemplated. It should be understood that the system 100 illustrated in FIG. 1 is representative of an example system and that a variety of different system environments and configurations are contemplated and are within the scope of the present disclosure. For example, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Furthermore, various entities of the system may be integrated into a single computing device or system or divided into additional computing devices or systems, etc.

For example, depending on the implementation, the climate event predictor 220 may be entirely server-side, i.e., at climate event predictor 220a, entirely client-side, i.e., at climate event predictor 220b, or distributed to between the client-side and server side, i.e., at climate event predictor 220a and climate event predictor 220b.

As another example, while only a single server 122 is illustrated, the server 122 may represent a plurality of servers (e.g., a server farm or distributed, cloud environment), and the server 122, in some implementations, may, therefore, include multiple instances (e.g., in different hardware servers, virtual machines, or containers) of the climate event predictor 220a.

FIG. 2 is a block diagram of an example server 122 including an instance of the climate event predictor 220a. In the illustrated example, the example the server 122 includes a processor 202, a memory 204, a communication unit 208, and, optionally, a display device 210, and input device 212, and an output device 214.

The processor 202 may execute software instructions by performing various input/output, logical, and/or mathematical operations. The processor 202 may have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual, and may include a single processing unit or a plurality of processing units and/or cores. In some implementations, the processor 202 may be capable of generating and providing electronic display signals to a display device, supporting the display of images, capturing and transmitting images, and performing complex tasks and determinations. In some implementations, the processor 202 may be coupled to the memory 204 via the bus 206 to access data and instructions therefrom and store data therein. The bus 206 may couple the processor 202 to the other components of the server 122 including, for example, the memory 204, the communication unit 208.

The memory 204 may store and provide access to data for the other components of the server 122. The memory 204 may be included in a single computing device or distributed among a plurality of computing devices. In some implementations, the memory 204 may store instructions and/or data that may be executed by the processor 202. The instructions and/or data may include code for performing the techniques described herein. For example, in some implementations, the memory 204 may store an instance of the climate event predictor 220a. The memory 204 is also capable of storing other instructions and data, including, for example, an operating system, hardware drivers, other software applications, databases (e.g., database 120), etc. The memory 204 may be coupled to the bus 206 for communication with the processor 202 and the other components of the server 122.

The memory 204 may include one or more non-transitory computer-usable (e.g., readable, writeable) device, a static random access memory (SRAM) device, a dynamic random access memory (DRAM) device, an embedded memory device, a discrete memory device (e.g., a PROM, FPROM, ROM), a hard disk drive, an optical disk drive (CD, DVD, Blu-ray™, etc.) mediums, which can be any tangible apparatus or device that can contain, store, communicate, or transport instructions, data, computer programs, software, code, routines, etc., for processing by or in connection with the processor 202. In some implementations, the memory 204 may include one or more of volatile memory and non-volatile memory. It should be understood that the memory 204 may be a single device or may include multiple types of devices and configurations.

The communication unit 208 is hardware for receiving and transmitting data by linking the processor 202 to the network 102 and other processing systems. The communication unit 208 receives data and transmits the data via the network 102. The communication unit 208 is coupled to the bus 206. In some implementations, the communication unit 208 may include a port for direct physical connection to the network 102 or to another communication channel. For example, the communication unit 208 may include an RJ45 port or similar port for wired communication with the network 102. In another implementation, the communication unit 208 may include a wireless transceiver (not shown) for exchanging data with the network 102 or any other communication channel using one or more wireless communication methods, such as IEEE 802.11, IEEE 802.16, Bluetooth® or another suitable wireless communication method.

In yet another implementation, the communication unit 208 may include a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still another implementation, the communication unit 208 may include a wired port and a wireless transceiver. The communication unit 208 also provides other connections to the network 102 for distribution of files and/or media objects using standard network protocols such as TCP/IP, HTTP, HTTPS, and SMTP as will be understood to those skilled in the art.

The input device 212 may include any device for inputting information into the server 122. In some implementations, the input device 212 may include one or more peripheral devices. For example, the input device 212 may include a keyboard, a pointing device, microphone, an image/video capture device (e.g., camera), a touch-screen display integrated with the output device 214, etc.

The output device 214 may be any device capable of outputting information from the server 122. The output device 214 may include one or more of a display (LCD, OLED, etc.), a printer, a 3D printer, a haptic device, audio reproduction device, touch-screen display, a remote computing device, etc. In some implementations, the output device 214 is a display which may display electronic images and data output by a processor for presentation to a user.

It should be apparent to one skilled in the art that other processors, operating systems, inputs (e.g., keyboard, mouse, one or more sensors, microphone, etc.), outputs (e.g., a speaker, display, haptic motor, etc.), and physical configurations are possible and within the scope of the disclosure.

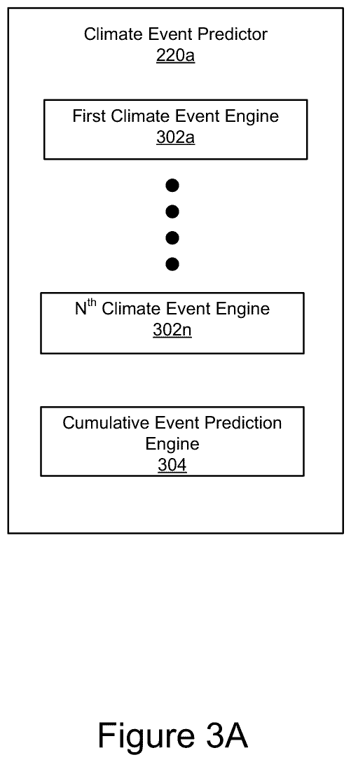

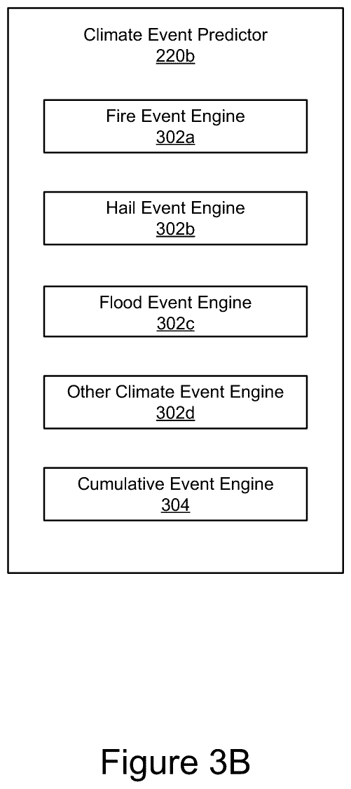

Referring now to FIG. 3A, a block diagram of an example instance of the climate event predictor 220a is illustrated in accordance with some implementations. In some implementations, the climate event predictor 220 may include one or more climate event engines, for example, first risk engine 302a through Nth risk engine 302n, where N may be any positive integer. As noted above, in some implementations, N=2 and there are two risk engines 302a and 302n. The risk engines 302a-302n may be referred to collectively as risk engines 302 or individually as risk engine 302 herein.

In some implementations, different climate event engines 302 may be associated with different climate events. For example, referring to FIG. 3B, a block diagram of another example climate event predictor 220b is illustrated in accordance with some implementations. In the illustrated implementation of FIG. 3B, the instance of the climate event predictor 220b includes a fire risk engine 302a for determining a fire (e.g. wildfire) risk using artificial intelligence, a hail risk engine 302b determining a hail risk using artificial intelligence, a flood risk engine 302c determining a flood risk using artificial intelligence, and an other climate event engine 302d determining another climate event (e.g. tornado, wind, hurricane, lightning, drought, etc.) using artificial intelligence.

Referring to FIGS. 3A & B, in some implementations, a climate event predictor 220 may include a cumulative risk engine 304 for determining a cumulative risk for one or more of a set of climate events and a collection of properties. In some implementations, the cumulative risk engine 304 determines a cumulative risk for one or more of a set of climate events. Referring to FIG. 3A, the cumulative risk engine 304 receives the output from the first risk engine 302 through the N^{th} risk engine 302n (e.g., scores) and uses the output to determine a cumulative risk score for the first through N^{th} climate events. Referring to FIG. 3B, the cumulative risk engine 304 receives the output from the fire risk engine 302a, the hail risk engine 302b, the flood risk engine 302c, and an other climate event engine 302d (e.g., scores) and uses the output to determine a cumulative risk score associated with a combination of fire, flood, hail, and an other climate event (e.g., wind, tornado, hurricane, drought, etc.).

In some implementations, the cumulative risk engine 304 provides a view of the cumulative risk for a collection, or portfolio, of locations or properties. For example, in some implementations the cumulative risk engine 304, uses scores associated with individual properties and climate events and generates both expected loss metrics (i.e., average) and probable loss metrics (i.e., various percentiles such as 99th percentile, 95th percentile, 90th percentile, 80th percentile etc.) across multiple climate events.

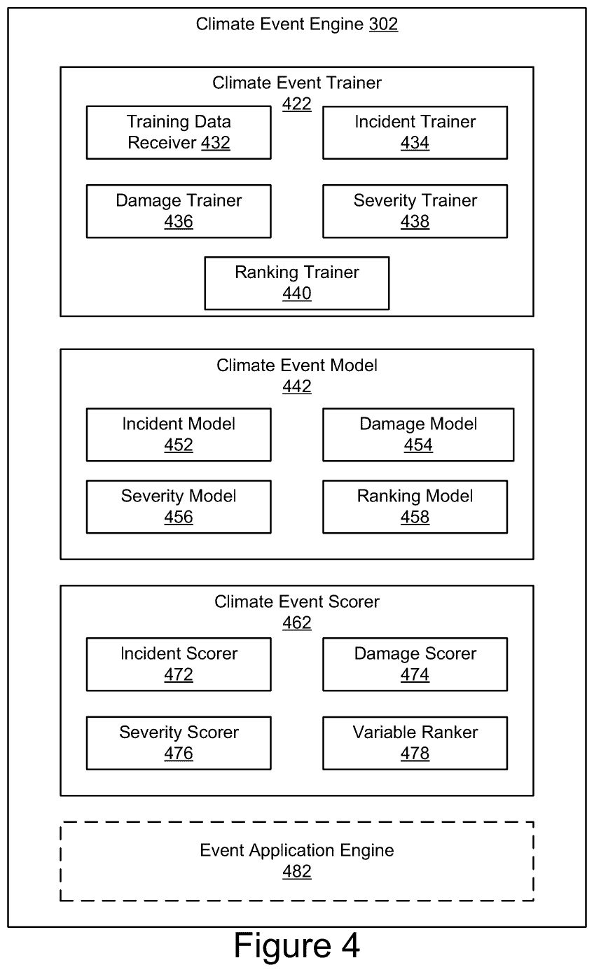

Referring now to FIG. 4, a block diagram of an example risk engine 302 is illustrated in accordance with some implementations. In the illustrated implementation of FIG. 4, the risk engine 302 includes a climate event trainer 422, a climate event model 442, a climate event scorer 462, and, optionally, a risk application engine 482.

The climate event trainer 422 receives property data and trains, using artificial intelligence, a climate event model 442, which may also occasionally be referred to herein as a “climate event algorithm” or similar, which is associated with a climate event. The climate event scorer 462 receives a property location and uses the climate event model 442 to generate a score representing the probability of a (damaging) climate event for the property at the location. In some implementations, the optional risk application engine 482 may take an action based on the score representing the first climate event to the property.

In some implementations, the climate event trainer 422 passes the climate event model 442 to the climate event scorer 462. For example, the climate event trainer 422 is communicatively coupled to the climate event scorer 462 to send the climate event model 442. In another implementation, the climate event trainer 422 stores the climate event model 442 in memory 204 (or any other non-transitory storage medium communicatively accessible), and the climate event scorer 462 may retrieve the climate event model 442 by accessing the memory 204 (or other non-transitory storage medium).

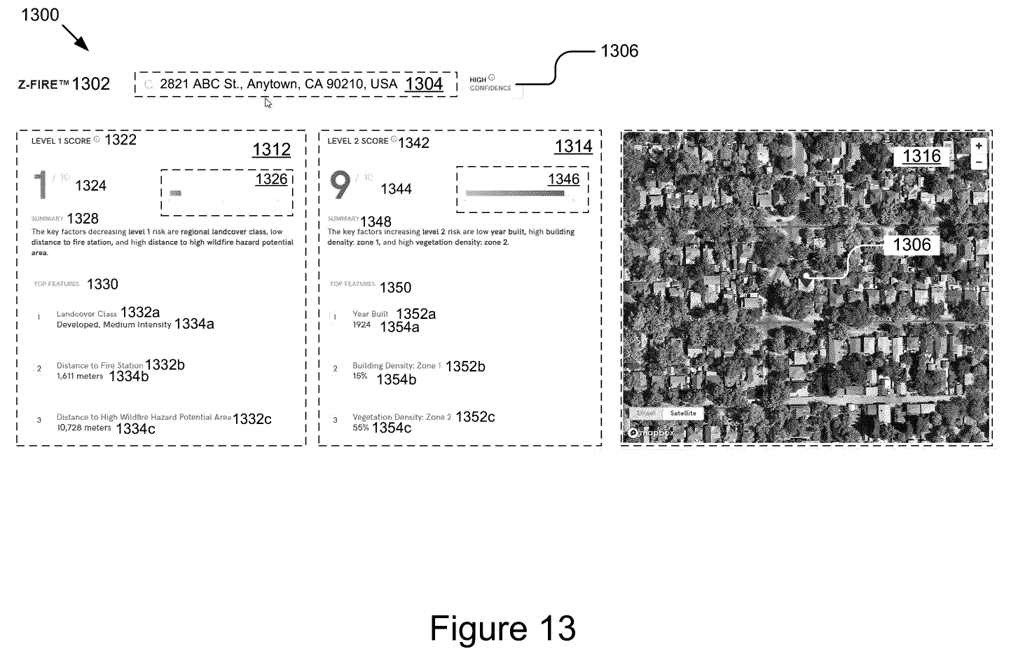

In some implementations, the climate event scorer 462 passes the one or more scores representing a probability of a (damaging) climate event to one or more of the client device 106 for presentation to the user 112 (e.g., as user interface 1300 of FIG. 13), a risk application engine 482 to take action(s) based on one or more of the scores, and a cumulative risk engine 304 as an input to generate a cumulative risk. For example, the climate event scorer 462 is communicatively coupled to the client device 106, the risk application engine 482, and the cumulative risk engine 304 to send the one or more scores representing a a likelihood of a (damaging) climate event. In another implementation, the climate event scorer 462 stores the one or more scores in memory 204 (or any other non-transitory storage medium communicatively accessible), and the to the client device 106, the risk application engine 482, and the cumulative risk engine 304 may retrieve the one or more scores by accessing the memory 204 (or other non-transitory storage medium).

In the illustrated implementation of FIG. 4, the climate event trainer 422 includes a training data receiver 432, an incident trainer 434, a damage trainer 436, a severity trainer 438, and a ranking trainer 440; the climate event model 442 includes an incident model 452, a damage model 454, a severity model 456, and a ranking model 458; and the climate event scorer 462 includes incident scorer 472, a damage scorer 474, a severity scorer 476, and a variable ranker. However, it should be recognized that the risk engine 302, depending on the implementation, may include one or more other trainers, models, or scorers, or omit one or more of the trainers 434/436/438/440, models 452/454/456/458, or scorers 472/474/476/478 without departing from the disclosure herein.

In some implementations, the climate event trainer 422 may train multiple climate event models associated with a climate event. For example, in some implementations, an instance of the climate event trainer 422 associated with the fire risk engine 302a may train an incident model 452, a damage model 454, a severity model 456, and a ranking model 458 associated with the risk of wildfire. In another example, an instance of the climate event trainer 422 associated with the flood risk engine 302c may train an incident model 452, a damage model 454, a severity model 456, and a ranking model 458 associated with the risk of flood.

In the illustrated implementation, the training data receiver 432 obtains data used by the incident trainer 434 to train an incident model 452, a damage trainer 436 to train a damage model 454, a severity trainer 438 to train a severity model 456, and a ranking trainer 440 to train a ranking model 458. The data received and used by the climate event trainer 422, or components 434/436/438/440 thereof, may vary based on implementation and use case. For example, the data received and used by the climate event trainer 422, or components 434/436/438/440 thereof, may vary based on one or more of the climate event and the model being trained. For example, the data obtained and used to train an incident model 452 for fire may at least partially differ from that obtained and used to train an incident model 452 for flood, and/or the data obtained and used to train a damage model 454 for wildfire.

The training data receiver 432 is communicatively coupled to receive training data, for example from a data source 120a/b, database 120, or any other non-transitory data store or any other data source. For example, one or more databases (no shown) maintained by a third-party such as a government or private party (e.g., a business such as an insurer). The training data receiver 432 is communicatively coupled to the climate event trainer 422, its components 434/432/434/436/438/440, and subcomponents 502/504/506/508/502a/504a/506a/508a/502b/504b/506b/508b, which may receive or accessed the training data.

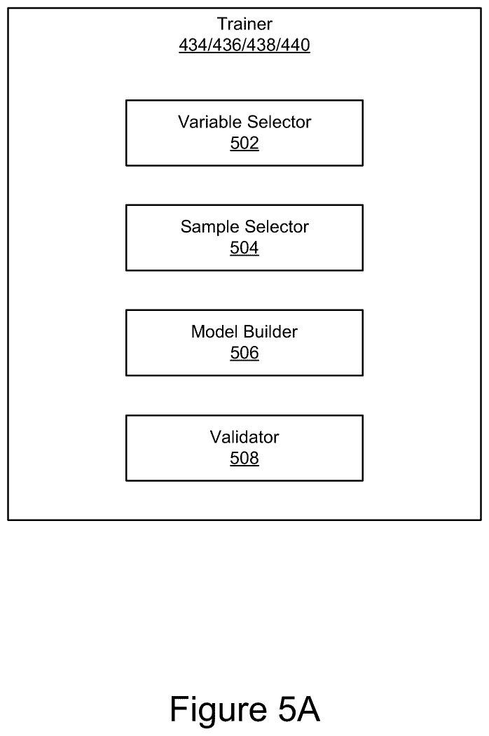

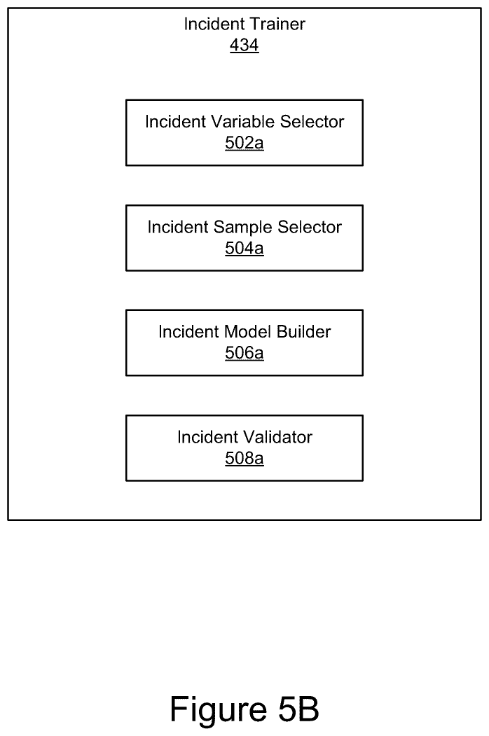

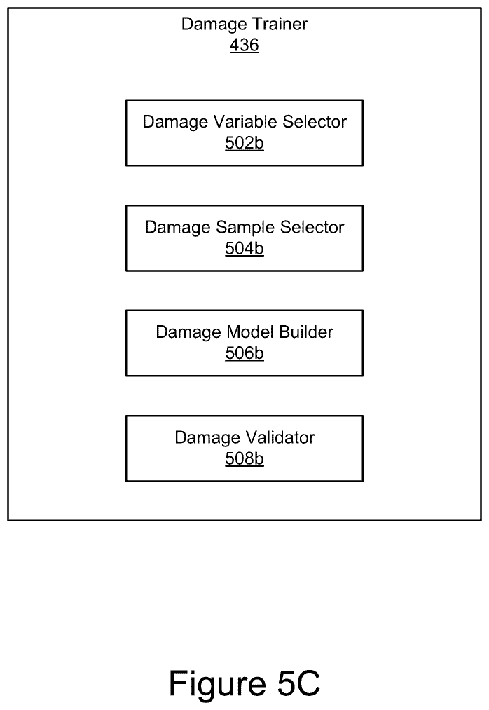

Referring now to FIG. 5A, in some implementations, the climate event trainer 422 includes one or more trainers 434/436/438/440 each having a sample selector 504, a variable selector 502 a model builder 506, and a validator 508. In some implementations, the climate event trainer 422 may include multiple trainers 434/436/438/440, where each trainer 434/436/438/440 instance is associated with a different climate event model452/454/456/458. For example, referring now to FIG. 5B, a block diagram of an example incident trainer 434 for training an incident model 452 is illustrated and includes an incident sample selector 504a, an incident variable selector 502a, an incident model builder 506a, and an incident validator 508a. As another example, referring now to FIG. 5C, a block diagram of an example damage trainer 436 for training a damage model 454 is illustrated and includes an incident trainer 434 includes a damage sample selector 504b, a damage variable selector 502b, a damage model builder 506b, and a damage validator 508b. A variable may also be occasionally referred to herein as a “feature.”

In some implementations, one or more components 502/502a/502b/504/504a/504b/506/506a/506b/508/508a/508b of a trainer 434/436/438/440 may be communicatively coupled to one another to pass data and information to provide the features and functionality described below. In some implementations, one or more components 502/502a/502b/504/504a/504b/506/506a/506b/508/508a/508b of a trainer 434/436/438/440 may stores the data and information to provide the features and functionality described below in memory 204 (or any other non-transitory storage medium communicatively accessible) for retrieval by one or more other components 502/502a/502b/504/504a/504b/506/506a/506b/508/508a/508b of a trainer 434/436/438/440 by accessing the memory 204 (or other non-transitory storage medium).

A variable selector 502may perform one or more of target variable definition, identification and validation of data sources, variable reduction, variable extraction, and variable localization. One or more of the target variable definition, identification and validation of data sources, variable reduction, and variable extraction localization may vary depending on the climate event or the scorer being trained.

In some implementations, the variable selector 502 receives a target variable definition. The target variable definition may vary based on the score type (e.g., incident, damage, severity, or rank), occasionally referred to herein as level. For example, in some implementations, the incident variable selector 502a may define the target variable as a probability of an incident occurring. Examples of target variables include the probability of a location falling within a wildfire perimeter for a wildfire climate event, a probability of a hail event at a location for a hail climate event, a probability of a flood event at a location for a flood climate event, and so on. As another example, in some implementations, the damage variable selector 502b defines the target variable as an amount of damage likely to occur. For example, the target variables may be a conditional probability that a structure or property will be destroyed if involved in a wildfire climate event, a probability, or extent, of damage to a property if involved in a hail event, a probability, or extent, of damage to a property if involved in a flood, and so on.

In some implementations, the variable selector 502 receives identification and validation of data sources storing historical data from which a training and target dataset may be generated. The data sources and historical data may vary based on a number of factors including, but not limited to, a region of interest, a type of score, and a type of climate event. For example, the data sources and historic data may vary based on a region of interest because different countries have different governments, which may require or maintain different databases and may track and store data differently. As another example, the data sources and historic data may vary based on a type of score because certain types of loss data may be relevant some scores and not others (e.g., amounts paid out by insurers may be relevant to a damage or severity score, but not to a ranking or incident score). As yet another example, the data sources and historic data may differ based on the relevant climate event for example locations of, or distances to, a fire station may be relevant to a wildfire climate event, but not to a hail or flood climate event.

The historic data store in the identified data sources may vary. Examples may include, but are not limited to historical loss data, historical records of historic incidents of a climate event, weather (e.g., temperature, humidity, precipitation data, etc.), image data (e.g., satellite images, maps, etc.), and other data. It should be recognized that the aforementioned data, and the data described in the examples below are not exhaustive, and that other types of data and variables may be stored by the data sources and used herein for training and/or scoring.

In some implementations, the variable selector 502 performs variable reduction. For example, the variable selector 502 identifies (e.g., based on user input) a set of variables based on one or more of scientific findings (e.g., from experts or academic publications) of relevant variables, feature importance (e.g., information gain), and an average marginal contribution to the results. In some implementations, a variable was only considered when the variable is generatable by the system here in or available from a reputable source, provides a high-level of coverage (e.g., 95%+ in the continental US), and provides at least 98% accuracy when tested.

The reduced set of variables may vary based on the climate event being scored/assessed. For example, in some implementations, the variables for wildfire may be reduced to include one or more of vegetation variable(s), building variable(s), a roof material variable, a fire response variable (e.g., a distance to a fire station), location variable(s), and weather variables. As another example, in some implementations, the variables for hail may be reduced to include one or more of vegetation variable(s), building and parcel variable(s), location variable(s), and weather variables. As yet another example, in some implementations, the variables for flood may be reduced to include one or more of building and parcel variable(s), location variable(s), and weather variables.

The reduced set of variables may vary based on the type or level of scorer 472/474/476 being trained. For example, in some implementations, the variables for a level 1, or incident scorer 472, for wildfire may be reduced to include the vegetation variable of the (categorical) type of vegetation/fuel on the property; a fire response variable including a distance (continuous) to a fire station; location variables including a distance (continuous) to a historic fire perimeter, a distance (continuous) to nearest fire station, a distance (continuous) to an area with high wildfire suppression difficulty, wildfire difficulty (discrete) at the location, and topography (categorical) or slope (continuous); and weather variables including average annual precipitation (continuous) and average annual temperature (continuous) at the location.

It should be understood that the foregoing is merely one example of variables that may be included in a reduced set of variables; however, other variables and combinations of variables are within the scope of this disclosure. For example, in some implementations, the reduced set of variables may include, but is not limited to, one or more of a distance to historical wildfire, a fuel source, special wind regions, rainfall/drought region, wildland urban interface, topography, forest continuity (e.g., average distance between trees in an adjacent forest), a distance to an area with high wildfire suppression difficulty, land cover, wildfire suppression difficulty, slope, aspect, temperature, precipitation, distance to nearest fire station, road access, predominance of ladder fuels, presence of fire breaks, canopy cover, canopy height, canopy base height, canopy density, vegetation health or quality, etc. Additionally, it should be understood that variable type (e.g., continuous or categorical) may vary depending on the implementation without departing from the disclosure herein. For example, precipitation may be continuous (e.g., inches of rainfall per period of time) or categorical (e.g., high/medium/low).

As another example, in some implementations, the variables for a level 2, or damage scorer 474, for wildfire may be reduced to include vegetation variables including an overhanging vegetation density (e.g., as a percentage (continuous) of a building footprint covered by the vegetation), a surrounding vegetation density (e.g., as a percentage (continuous) of the area in the immediate surroundings of the target building/property covered by vegetation), a neighboring vegetation density (e.g. as a percentage (continuous) of the area in a broader vicinity of the target building covered by vegetation), a fuel type (categorical) representing the type of vegetation/fuel on the property (e.g., a spatial reference and descriptive data for characteristics of land cover as a thematic class); building and parcel variables including a year (categorical) of construction, a roof material (categorical) of a target building, and a land slope (continuous); and a location variable including surrounding building density (e.g. as a percentage (continuous) of the surrounding area covered by other buildings).

It should be understood that the foregoing is merely one example of variables that may be included in a reduced set of variables; however, other variables and combinations of variables are within the scope of this disclosure. For example, in some implementations, the reduced set of variables may include, but is not limited to, one or more of vegetation coverage by zone, forest coverage by zone, bare earth coverage by zone, forest continuity (average distance between trees in an adjacent forest), adjacency of forest canopy to building, predominance of ladder fuels, slope, Northness (Cosine of the aspect), exposure (aspect ratio of structure relative to the downhill direction within zone), building density by zone, roof material, siding material, construction design, distance to local fire station, distance to nearest vegetation, vegetation health or quality, presence of deck, presence of combustible material, presence of fuel tanks, presence of debris, property maintenance, overhanging vegetation density, year built, land cover, type of local wildfire building codes, road access, etc. Additionally, it should be understood that variable type (e.g., continuous or categorical) may vary depending on the implementation without departing from the disclosure here. For example, vegetation density may be continuous (e.g., a percentage of the area in a broader vicinity of the target building covered by vegetation) or categorical (e.g., high/medium/low).

As another example, in some implementations, the variables for a level 1, or incident scorer 472, for hail may be reduced to include location variables including elevation, historical hail frequency, distance to historical hail events, topography, distance to mountains; and weather variables including average humidity, hail diameter and density, wind speed and direction, storm length, and precipitation.

As another example, in some implementations, the variables for a level 2, or damage scorer 474, for hail may be reduced to include roof variables including roof surface area, roof material, roof shape, roof facets, roof quality/useful life, skylights (e.g., presence and/or percentage of roof), solar panels (e.g., presence and/or percentage of roof); building and parcel variables including year built, square footage, secondary buildings (e.g., presence roof and/or the roof variables mentioned for the secondary buildings), building height, and build orientation; and vegetation variables including overhanging vegetation (e.g. a percentage of the roof) and vegetation height. In some implementations, the variables for a level 2, or damage scorer 474, for hail may also include location variables including elevation, historical hail frequency, distance to historical hail events, topography, distance to mountains; and weather variables including average humidity, hail diameter and density, wind speed and direction, storm length, and precipitation.

As another example, in some implementations, the variables for a level 1, or incident scorer 472, for flood may be reduced to include location variables including elevation, slope, aspect, distance to nearest body of water, distance to nearest source of water, distance to nearest river or stream, presence of flood breaks, elevation relative to nearest body of water, topography, distance to historical flood zone; presence of historical flood, drought zone, distance to levee; and weather variables including annual rainfall.

As another example, in some implementations, the variables for a level 2, or damage scorer 474, for flood may be reduced to include building or parcel variables including first floor elevation, a year built, a number and/or size of windows at ground level, number and/or size of doors at ground level, building material(s), roof material, siding material, presence of a basement, elevation relative to neighbor, elevation relative to street level, presence of submerged pumps, presence of French drains; location variables including lowest adjacent grade, highest adjacent grade, land slope. In some implementations, the variables for a level 2, or damage scorer 474, for flood may also include location variables including elevation, slope, aspect, distance to nearest body of water, distance to nearest source of water, distance to nearest river or stream, presence of flood breaks, elevation relative to nearest body of water, topography, distance to historical flood zone; presence of historical flood, drought zone, distance to levee; and weather variables including annual rainfall

In some implementations, the variable selector 502 performs variable transformation and extraction to create certain derived variables. For example, in some implementations, one or more of the aforementioned variables are obtained by the variable selector 502 during training through transformation and extraction. For example, the variable selector 502 transforms image data into structured data (e.g., the variables described above). Image data may vary based on the implementation. Examples of image data may include, but are not limited to, aerial imagery (e.g., from a drone or satellite), street-level views (e.g., from Google's Street View), images from an insurance adjuster (e.g., of the building, property, or damage), images from a real-estate cite (e.g., the MLS, Zillow, etc.), and other types of images from other sources. In some implementations, the image data may include one or more of visible/RGB spectrum images, infrared spectrum images, and LIDAR/laser generated images. In some implementations, satellite data may include satellite imagery having one or more resolutions. For example, in some implementations, the satellite imagery may have a resolution of up to 30 cm ground sampling distance (GSD) or the distance represented by the center of one pixel to the center of an adjacent pixel in the image.

For example, the variable selector 502 analyzes the image data (e.g., an aerial image) to determine one or more variables used to generate a score for a location. For example, in some implementations, the variable selector may analyze image data (e.g., a most recent, available satellite image) to extract vegetation variables including an overhanging vegetation density (e.g., as a percentage (continuous) of a building footprint covered by the vegetation), a surrounding vegetation density (e.g., as a percentage (continuous) of the area in the immediate surroundings of the target building/property covered by vegetation), a neighboring vegetation density (e.g. as a percentage (continuous) of the area in a broader vicinity of the target building covered by vegetation), a fuel type (categorical) representing the type of vegetation/fuel on the property (e.g., a spatial reference and descriptive data for characteristics of land cover as a thematic class); building and parcel variables including a roof material (categorical) of a target building, and a land slope (continuous); and a location variable including surrounding building density (e.g. as a percentage (continuous) of the surrounding area covered by other buildings), which were described above with reference to an example for the level 2/damage training for wildfire.

For clarity and convenience, the foregoing describes numerous example variables and combinations of example variables. However, it should be recognized that the foregoing examples are not exhaustive, and variables, variable types, and combinations of variables other than those described above may be used without departing from the disclosure herein. For example, other variables may be transformed and extracted from image data by the variable selector 502 and used without departing from the disclosure herein.

In some implementations, the variable selector localizes the data set. For example, in some implementations, variables are associated with a location, such as the location of the property that a variable's value describes.

A sample selector 504 builds a random sample data set. The random sample set may vary based on the climate event and the scorer to be trained. For example, in some implementations, a random sample set may be selected to include a threshold amount of damage, or undamaged, properties, and the threshold is not necessarily the same and may differ based on the climate event, the model being trained, the implementation, or a combination thereof.

In some implementations, the random sample data set may have a 50% positive and 50% negative split for training purposes. For example, in some implementations, the incident sample selector 504a builds a data set where 50% of properties were involved in an incident of a climate event (e.g., 50% were in a wildfire/flood/hail/other, depending on the climate event) and 50% were not.

In some implementations, the random sample data set may have a 30% positive and 70% negative split for training purposes. For example, in some implementations, the damage sample selector 504b builds a data set where 30% of properties were damaged in an incident of a climate event (e.g., 30% were damaged by wildfire/flood/hail/other, depending on the climate event) and 70% were not.

It should be recognized that the 50/50 data set for training an incident model 452 and the 30/70 data set for training a damage model 454 are merely illustrative examples, and different percentages may be used and are within the scope of this disclosure.

In some implementations, the sample selector 504 selects a portion of data for testing. For example, the sample selector 504 generates a hold-out population of data not in the training set and used to test a trained model. In some implementations, the hold-outs are selected based on a parameter, e.g., time, region, etc. For example, in some implementations, the hold-outs are based on a time period, e.g., to determine whether a model trained over one period of time (e.g., data over the last ten years) can accurately predict on data over another period of time (e.g., the last five years), to determine a minimum period for accurate results (e.g., at least 3 years of data), or to determine a maximum period of time for accurate results, e.g., because patterns have changed and the more recent data is more predictive. In another example, in some implementations, the hold-outs are based on a geographic location or region, to determine whether a model trained using data in one area, which may or may not have more historic climate event incident data or damage data, is predictive in another area (held-out), which may or may not have less climate event incident or damage data. It should be recognized that the foregoing are examples of hold-out criteria and other criteria may be used without departing from the disclosure herein.

A model builder 506 uses a training set to train a model. For example, referring again to FIG. 5B, the incident model builder 506a of the incident trainer 434 trains an incident model 452. As another example, referring again to FIG. 5C, the damage model builder 506b of the damage trainer 436 trains a damage model 454.

The model trained by the model builder 506 may vary based on one or more of an implementation, use case, climate event, and type of score. Accordingly, different types of scorers (e.g., incident scorer 472 and damage scorer 474) may not necessarily use the same type of machine learning model even for a given climate event (e.g., wildfire), and the scorers associated with different climate events (e.g., fire and hail) may not necessarily use the same type of machine learning model.

The varieties of supervised, semi-supervised, unsupervised, reinforcement learning, topic modeling, dimensionality reduction, meta-learning and deep learning machine learning algorithms, which may be used to generate the models 442/452/454/456/458 described herein, are so numerous as to defy a complete list. Examples algorithms 442/452/454/456/458 include, but are not limited to, a decision tree; a gradient boosted tree, gradient boosted machine; boosted stumps; a random forest; a support vector machine; a neural network; logistic regression (with regularization), linear regression (with regularization); stacking; a Markov model; support vector machines; and others. For clarity and convenience, implementations using a gradient boosted tree or gradient boosted machine are referred to as an example and described in detail. However, it should be recognized that the disclosure herein is not limited to implementations using a gradient boosted tree or gradient boosted machine and the models 442/452/454/456/458 may use other artificial intelligence algorithms.

In some implementations, the climate event trainer 422 trains a gradient boosted machine (GBM) for one or more of the climate event models 442/452/454/456/458. In some implementations, the goal of the GBM model being trained is to find a function that minimizes a loss function, e.g., a cross entropy loss. The climate event trainer 422, a component 434/436/438/440, or a subcomponent 506/526 thereof, fits an initial decision tree on a subset of the training data with features used to split data, and splits the training data by determining which features maximize information gain (or minimize cross entropy loss). Following the initial decision tree, additional trees may be fit to the residuals of the loss function using the above methodology in a sequential manner. At prediction/evaluation time, all fitted decision trees in the ensemble are used, e.g., by the climate event scorer 462 or a component 472/474/476/478 thereof, to generate the model output.

A validator 508 validates the model trained by the machine model builder. For example, referring again to FIG. 5B, the incident validator 508a of the incident trainer 434 validates the incident model 452. As another example, referring again to FIG. 5C, the damage validator 508b of the damage trainer 436 validates the damage model 454. In some implementations, the validation ensures one or more of an appropriate classification of risk, and both the positive and negative discriminating power of the model.

Depending on the implementation, the climate event, and the type of model (e.g., incident, damage, severity, or ranking) being validated, the validation metric(s) used may vary. In some implementations, three validation metrics are used to qualify the validation of a model 452/454/456/458 on a hold-out population:
1) Sum of target (in a binary 0-1 form)/Sum of observed the model
   i) L1: Inclusion rate-% of actual observation (specific geo-location) involved in a subsequent climate event incident for a given score.
   ii) L2: Damage rate-% of actual observation (specific structure) damaged if involved in a climate event incident. Labelled pre and post imagery is leveraged for validation. All or any portion of the labelled data may be validated by humans in different implementations.
2) F1 Score: A measure of a test's accuracy which is sensitive to both the precision and the recall of the test where an F1 score reaches its best value at 1 (perfect precision and recall) and worst at 0.

$$F 1 = ( 2 * Precision * Recall ) / ( Precision + Recall )$$

$$Precision = True Positive / ( True Positive + False Positive ) \to Number of items correctly identified as positive out of total items identified as positive$$

$$Recall = True Positive / ( True Positive + False Negative ) \to Number of items correctly identified as positive out of total true positives$$

3) Receiver Operating Characteristic (ROC): If chosen at random, a positive case and a negative case, the probability that the positive case outranks the negative case (in score) according to the classifier is given by the Area Under the ROC Curve (AUC). An AUC of 0.5, for an equally weighted sample, would represent a random model without predictive power.

Both F1 and ROC indicate the ability of the model to discriminate between areas likely to be in a climate event and those not (L1) and between structures likely to be damaged or left standing (L2).

In some implementations, level 1 scores are structured as a binary classifier for those tests where:

$$True Positive : Score >= 0.5 and Actual = Included in a fire perimeter$$

$$True Negative : Score < 0.5 and Actual = Not included in a fire perimeter$$

$$False Positive : Score >= 0.5 and Actual = Not included in a fire perimeter$$

$$False Negative : Score < 0.5 and Actual = Included in a fire perimeter$$

In some implementations, the validator 508 may adapt or retrofit the model trained by the machine model builder to address one or more model biases (e.g., over-fitting, survival biases, availability, second order impacts, etc. For example, referring again to FIG. 5B, the incident validator 508a of the incident trainer 434 adapts or retrofits the incident model 452. As another example, referring again to FIG. 5C, the damage validator 508b of the damage trainer 436 adapts or retrofits the damage model 454.

Referring again to FIG. 5B, the incident model builder 506a of the incident trainer 434 trains an incident model 452 according to some implementations. The incident model 452, when used by the climate event scorer 462, e.g., by the incident scorer 472, determines an incident score representing a likelihood of the climate event occurring at a property. In some implementations, the incident score represents a likelihood of the climate event occurring at a property on an annual basis. For example, an incident score determined, by the fire risk engine 302a, for a property represents a likelihood that the property will be involved in a wildfire. As another example, an incident score determined, by the hail risk engine 302b, for a property represents a likelihood that the property will be involved in a hail event. As another example, an incident score determined, by the flood risk engine 302c, for a property represents a likelihood that the property will be involved in a flood event. In some implementations, the cumulative risk engine 304, determines a cumulative incident score representing a cumulative likelihood of one or more of the climate events occurring at a property. In some implementations, the cumulative risk engine 304, determines a cumulative incident score representing a cumulative likelihood of one or more of the climate events occurring at a property on an annualized basis.

In some implementations, the incident trainer 434 passes the incident model 452 to the incident scorer 472. For example, the incident trainer 434 is communicatively coupled to incident scorer 472 to send the incident model 452. In another implementation, the incident trainer 434 stores the incident model 452 in memory 204 (or any other non-transitory storage medium communicatively accessible), and the incident scorer 472 may retrieve the incident model 452 by accessing the memory 204 (or other non-transitory storage medium).

Referring again to FIG. 5C, the damage model builder 506b of the damage trainer 436 trains a damage model 454. The damage model 454, when used by the climate event scorer 462, e.g., by the damage scorer 474, determines a damage score representing a likelihood of damage, caused by the climate event, to the property. In some implementations, the damage score represents a likelihood of damage, caused by the climate event, occurring at a property on an annual basis. For example, a damage score determined, by the fire risk engine 302a, for a property represents a likelihood that the property will be damaged by wildfire. As another example, a damage score determined, by the hail risk engine 302b, for a property represents a likelihood that the property will be damaged in a hail event. As another example, a damage score determined, by the flood risk engine 302c, for a property represents a likelihood that the property will be damaged in a flood event. In some implementations, the cumulative risk engine 304, determines a cumulative damage score representing a cumulative likelihood of damage to the property from a plurality of climate events. In some implementations, the cumulative risk engine 304, determines a cumulative damage score representing a cumulative likelihood of damage to the property from a plurality of climate events on an annualized basis.

In some implementations, the damage trainer 436 passes the damage model 454 to the damage scorer 474. For example, the damage trainer 436 is communicatively coupled to damage scorer 474 to send the damage model 454. In another implementation, the damage trainer 436 stores the damage model 454 in memory 204 (or any other non-transitory storage medium communicatively accessible), and the damage scorer 474 may retrieve the damage model 454 by accessing the memory 204 (or other non-transitory storage medium).

While not shown, in some implementations, trainers similar to the incident trainer of FIG. 5B and the damage trainer of FIG. 5C may exist for the severity trainer 438 and the ranking trainer 440.

Referring again to FIG. 4, the severity model 456, when used by the climate event scorer 462, e.g., by the severity scorer 476, determines a severity score representing a severity of damage to the property expected from an incident of the climate event. In some implementations, the severity score represents a severity of damage, caused by the climate event, occurring at a property on an annual basis. For example, a severity score determined, by the fire risk engine 302a, for a property represents a severity of damage to a property expected by wildfire. As another example, a severity score determined, by the hail risk engine 302b, for a property represents a severity of damage to a property expected by hail. As another example, a severity score determined, by the flood risk engine 302c, for a property represents a severity of flood damage to a property. In some implementations, the cumulative risk engine 304, determines a cumulative severity score representing a cumulative severity of damage to a property from a plurality of climate events. In some implementations, the cumulative risk engine 304, determines a cumulative severity score representing a cumulative severity of damage to a property from a plurality of climate events on an annualized basis.

In some implementations, the severity trainer 438, severity model 456, and severity scorer 476 may be omitted. For example, in some implementations, the damage score represents a risk and an extent of damage if a property is involved in a climate event. In some implementations, where an incident of a climate event usually results in a total loss, the severity trainer 438, severity model 456, and severity scorer 476 may be omitted from the risk engine 302 associated with that climate event. For example, if, when a wildfire occurs at a property, the damage to the property is total; in some implementations, the fire risk engine 302a may omit a severity trainer 438, severity model 456, and severity scorer 476. Alternatively, in some implementations, the severity trainer 438 trains a severity model 456 that, when used by the severity scorer 476, determines a maximum severity per incident of the climate event, e.g., a total loss in the event of a wildfire.

In some implementations, the severity trainer 438 passes the severity model 456 to the severity scorer 476. For example, the severity trainer 438 is communicatively coupled to severity scorer 476 to send the severity model 456. In another implementation, the severity trainer 438 stores the severity model 456 in memory 204 (or any other non-transitory storage medium communicatively accessible), and the severity scorer 476 may retrieve the severity model 456 by accessing the memory 204 (or other non-transitory storage medium).

The ranking model 458, when used by the climate event scorer 462, e.g., by the variable ranker 478, determines, for each feature from a set of features associated with the property and used to determine a score (e.g., an incident, a damage, a severity, a collective, or a cumulative score), a relative impact of the feature on that score and may order, or rank, the features based on their relative impact. In some implementations, the variable ranker 478 generates a set of the most impactful features to a user, so that the user may understand what property features are most responsible for the determined score. Some property features may not be easily, or realistically, remediable (e.g., average precipitation, average temperature, elevation, building density, etc.) to lower the risk of an incident, risk of damage, or severity of damage, while other features (e.g., roof material, presence of overhanging vegetation, fuel types present on property, etc.) may be more easily changed or remediated by a property owner. In some implementations, the variable ranker 478 determines a set of the most impactful, remediable features. In some implementations, the variable ranker or risk application engine 482, depending on the implementation, may send the set of the most impactful, user remediable features to a user. For example, informing the user of what property features are most responsible for the determined score and are remediable. In some implementations, the variable ranker 478 may identify the least impactful features and/or least impactful, remediable features instead or in addition to the most impactful.

The size of the ranked set of features may vary depending on the implementation or use case. For example, the variable ranker 478 may determine zero, one, two, three, four, or five features having the greatest relative impact, or least relative impact, depending on the implementation. In some implementations, the variable ranker 478 may not determine the same number of most impactful features as least impactful features.

In some implementations, the ranking model 458 may be omitted. For example, in some implementations, or for certain use cases, the features most impactful to a score may be irrelevant or may not be of interest and the ranking trainer 440, the ranking model 458, and the variable ranker 478 may be omitted.

In some implementations, the determination of relative impact and ranking described above, with reference to the ranking trainer 440, the ranking model 458, and the variable ranker 478 may result as a bi-product of one or more of the other trainers 434/436/438 or one or more of the scorers 472/474/476. For example, when one of the trainers 434/436/438 or scorers 472/474/476 uses a Gradient Boosted Machine (GBM), or Gradient Boosted Trees (GBT); in some implementations, as the model is trained, or used in scoring, the features that maximize information gain, or minimize cross entropy loss, are determined to be the most impactful.

In some implementations, the ranking trainer 440 passes the ranking model 458 to the variable ranker 478. For example, the ranking trainer 440 is communicatively coupled to the variable ranker 478 to send the ranking model 458. In another implementation, the ranking trainer 440 stores the ranking model 458 in memory 204 (or any other non-transitory storage medium communicatively accessible), and the variable ranker 478 may retrieve the ranking model 458 by accessing the memory 204 (or other non-transitory storage medium).

The climate event scorer 462 uses the one or more climate event models 442 to generate one or more scores representing a a relative likelihood of an incident and/or a damaging incident, and/or extent of expected damage posed by a climate event. In some implementations, the score is associated with a specified property.

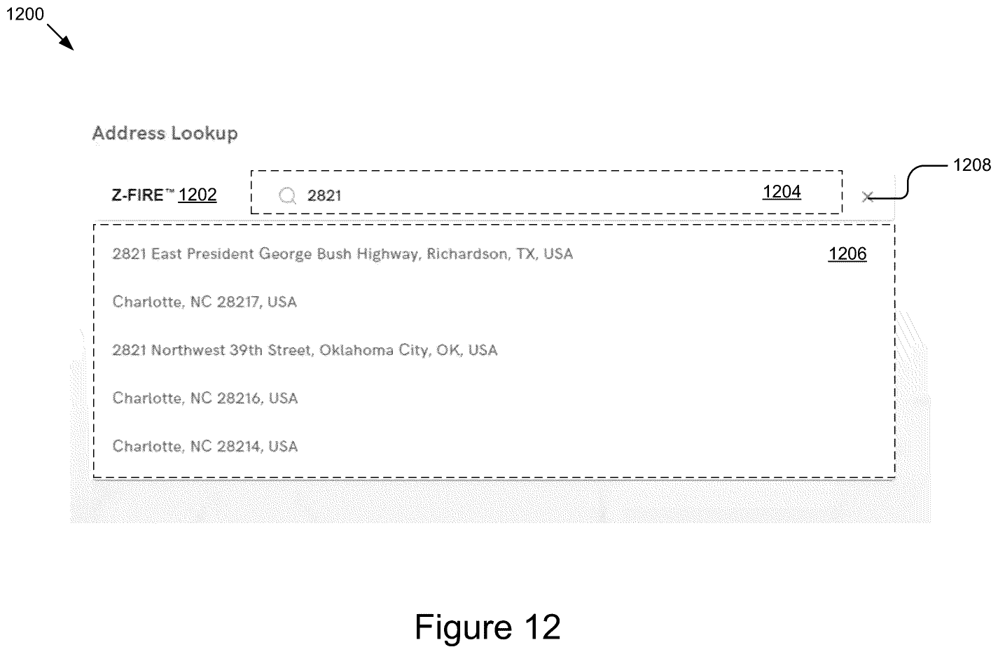

In some implementations, the climate event scorer 462 receives a location of a property (e.g., address, latitude and longitude, lot or parcel number, etc.). For example, the climate event scorer 462 receives the location of a property from a user interacting with a user interface, such as the user interface 1200 of FIG. 12 described further below.

In some implementations, the climate event scorer 462 obtains the location of the property, such as that entered into search field 1204 of example user interface 1200 illustrated in FIG. 12, obtains image data associated with the location, and uses the one or more climate event models, occasionally referred to as climate event algorithms, to generate a set of one or more scores representing a (relative) probability that a climate event will affect the property.

In some implementations, the climate event scorer 462 is communicatively coupled to a source of image data. For example, the climate event scorer 462 is communicatively coupled to image data associated with the location stored in memory 204 (or any other non-transitory storage medium or data source communicatively accessible), and the climate event scorer 462 may retrieve the image data by accessing the memory 204 (or other non-transitory storage medium or any other data source). For example, the climate event scorer 462 accesses one or more databases (not shown) maintained by a third-party such as a government (e.g., a government agency with satellite imagery) or private party (e.g., Google Earth Engine).

In some implementations, the climate event scorer 462 presents the set of one or more scores to a user. Depending on the implementation, a score may be numerical (e.g., 0-1, 1-10, 1-100, etc.) or categorical (e.g., low/medium/high or low/medium/high/extreme).

In some implementations, the climate event scorer 462 generates a single score for a climate event. For example, in some implementations, an instance of the climate event scorer 462 generates a single, collective risk score representing a collective risk posed by wildfire. In some implementations, climate event scorer provides a view of the collective risk for a collection, or portfolio, of locations or properties. For example, in some implementations the cumulative risk engine 304, uses scores associated with individual properties and climate events and generates both expected loss metrics (i.e., average) and probable loss metrics (i.e., various percentiles such as 99th percentile, 95th percentile, 90th percentile, 80th percentile, etc.) for a particular climate event.

In some implementations, the climate event scorer 462 may include a simulator for simulating an event (e.g., an origin of a wildfire, a location of a flood, or a location of a hail event), a hazard (e.g., a size or intensity of a wildfire or flood, or the size/kinetic energy of the hail event), a vulnerability (e.g., an extent to which a collection, or portfolio, of properties gets damaged, when in the simulated wildfire, flood, or hail event), and a financial (e.g., financial losses incurred by carriers for a given portfolio based on the scores determined by the climate event scorer 462, or its components 472/474/476/478).

In some implementations, the climate event scorer 462 generates a plurality of scores, wherein each of the scores, represents a different type of risk associated with the climate event. For example, in some implementations, the climate event scorer 462 may generate an incident score representing a likelihood of a climate event occurring at a property, a damage score representing a likelihood of damage from the climate event to the property, a severity score representing a severity of damage to the property to be expected from an incident of the first climate event. For example, the climate event scorer 462 generates an incident score and a damage score associated with the property and sends the scores for presentation in a user interface, such as the user interface 1300 of FIG. 13 described further below.

Depending on the implementation, the property may include, but is not limited to, one or more of a structure (e.g., house, barn, garage, shed, building, etc.), a portion of a structure (e.g., roof, basement, etc.), vehicle (car, boat, truck, etc.), crop (e.g., a field, orchard, etc.). In some implementations, the climate event scorer 462 presents the one or more scores to a user. Depending on the implementation, the user may be associated with an insurer, or potential insurer, a property owner, or other individual.

In some implementations, the climate event scorer 462 passes the score to the risk application engine 482. For example, the climate event scorer 462 is communicatively coupled to the risk application engine 482 to send the score. In another implementation, the climate event scorer 462 stores the score in memory 204 (or any other non-transitory storage medium communicatively accessible), and the risk application engine 482 may retrieve the score by accessing the memory 204 (or other non-transitory storage medium).

In some implementations, the risk engine 302 includes an optional risk application engine 482. In some implementations, the risk engine 302 may be omitted or present in a separate component or system, e.g., in a third-party system, such as server, or other computing device, associated with an insurer (not shown).

The risk application engine 482 applies one or more scores generated by the climate event scorer 462 to a property. In some implementations, the risk application engine 482 application of the one or more scores to the property determines one or more actions based on the one or more scores. In some implementations, the risk application engine 482 performs an action based on the one or more scores. In some implementations, the risk application engine 482 instructs another system to perform the determined action based on the one or more scores. Examples of actions may include, but are not limited to determining a remedial action to reduce a risk (e.g., eliminating vegetation overhanging a structure to reduce wildfire risk), suggesting a remedial action, approving insurance coverage associated with the climate event based on the score(s), denying insurance coverage associated with the climate event based on the score(s), adjusting an insurance premium associated with first climate event, sending a warning of the first climate event (e.g. via phone, e-mail, SMS/MMS text, mail, etc.) to the property or an owner, resident, financer, or insurer of the property.

### Example Methods

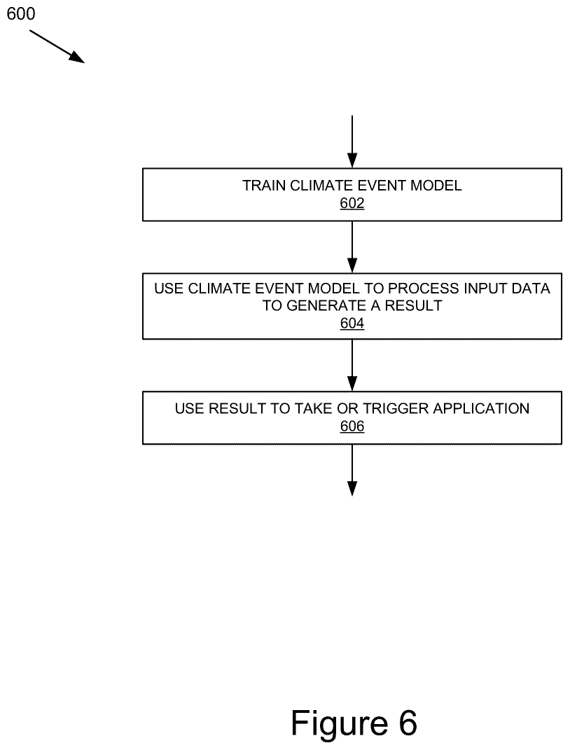

FIGS. 6-11 are flowcharts of example methods that may, in accordance with some implementations, be performed by the systems described above with reference to FIGS. 1-5B. The methods FIGS. 6-11 are provided for illustrative purposes, and it should be understood that many variations exist and are within the scope of the disclosure herein.

FIG. 6 is a flowchart of an example method 600 for assessing climate event(s) using artificial intelligence in accordance with some implementations. At block 602, the climate event trainer 422 trains a climate event model. At block 604, the climate event scorer uses the climate event model trained at block 602 to process input data to generate a result. At block 606, the risk application engine 482, optionally, uses the result generated at block 604 to take or trigger action.

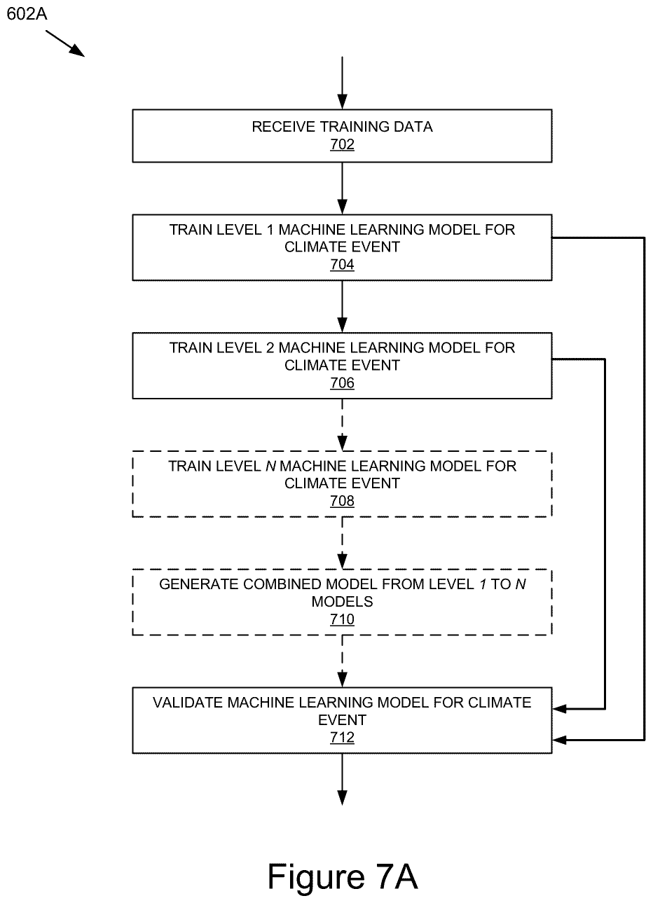

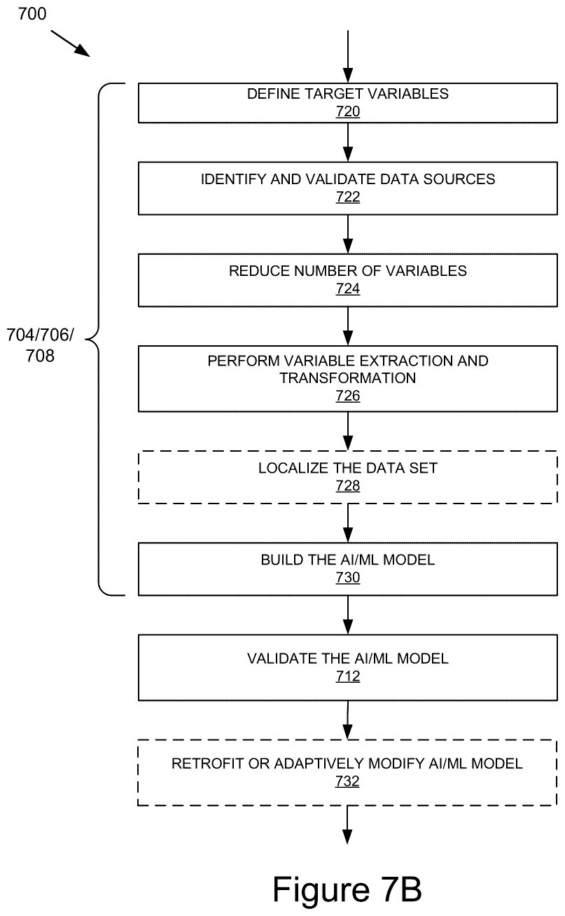

FIG. 7A is a flowchart of an example method 602A for training a climate event model in accordance with some implementations. At block 702, the training data receiver 432 receives training data. At block 704, the climate event trainer 422 trains a level 1 machine learning model for a climate event, and validates the level 1 model at block 712. For example, the incident trainer 434 trains on the training data received at block 702 to generate the incident model 452. As block 706, the climate event trainer 422 trains a level 2 machine learning model for a climate event, and validates the level 2 model at block 712. For example, the damage trainer 436 trains on the training data received at block 702 to generate the damage model 454. In some implementations, the method 602 may, optionally, train, as represented by block 708, N levels of machine learning (e.g., including a severity model 456 and/or a ranking model 458), and validate those N machine learning models at block 712. In some implementations, the climate event trainer 422 may, optionally, train a combined model (not shown), from the 1 to N models, for generating a combined score for a particular climate event, and validate the combined model at block 712.

FIG. 7B is a flowchart of another example method 700 for training a climate model in accordance with some implementations. Depending on the implementation, blocks 720-730 may describe one or more of training a level 1 machine learning model (i.e., block 704 of FIG. 7A), training a level 2 machine learning model (i.e., block 706 of FIG. 7A), and training a level N machine learning model (i.e., block 708 of FIG. 7A). For clarity and convenience, for blocks 720-732, the description below references the climate event trainer 422 and an AI/ML model. However, it should be understood that, depending on the implementation and use case, blocks 720-732 may be performed by an incident trainer 434, damage trainer 436, severity trainer 438, or ranking trainer 440, and the AI/ML model may refer to an incident model 452, a damage model 454, a severity model 456, or a ranking model 458, respectively.

At block 720, the climate event trainer 422 defines target variables. At block 722, the climate event trainer 422 identifies and validates data sources. At block 724, the climate event trainer 422 reduces the number of variables. At block 726, the climate event trainer 422 performs variable extraction and transformation. At block 728, the climate event trainer 422, optionally, localizes the data set. At block 730, the climate event trainer 422 builds the AI/ML Model. At block 712, the climate event trainer 422 validates the AI/ML model. At block 732, the climate event trainer 422 optionally retrofits, or adaptively modifies, the AI/ML model.

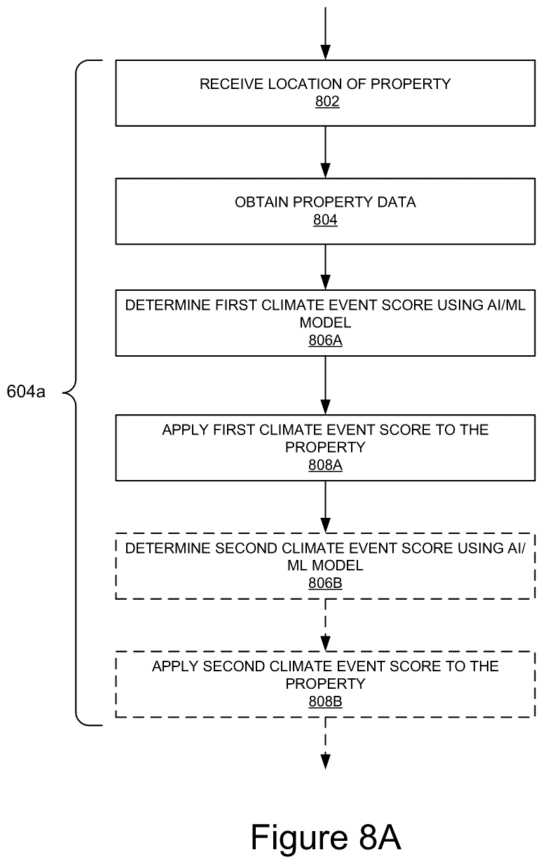

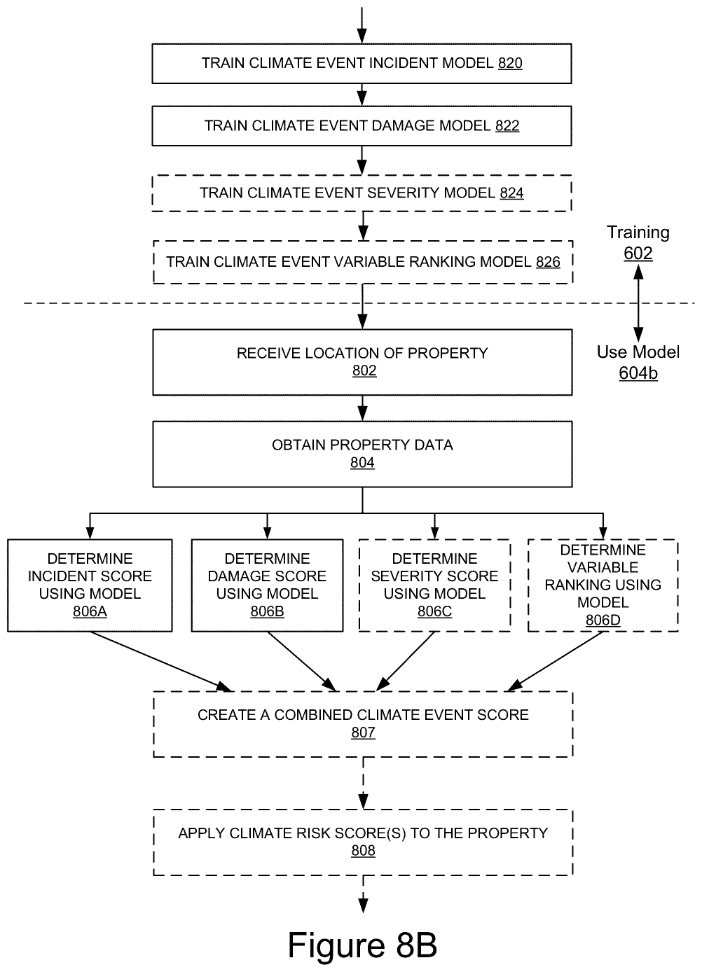

FIG. 8A is a flowchart of an example method 604a for using climate event model(s) on a property to generate a result in accordance with some implementations. At block 802, the climate event scorer 462 receives a location of a property. At block 804, the risk scorer 462 obtains property data associated with the property. At block 806A, the climate event scorer 462 determines a first climate event score (e.g., incident, damage, severity, or ranking score) using an AI/ML model (e.g., incident model 452, damage model 454, severity model 456, or ranking model, respectively). At block 808A, the risk application engine 482 applies the first climate event score to the property. At block 806B, the climate event scorer 462, optionally, determines a second climate event score (e.g., another from the incident, damage, severity, or ranking score) using an AI/ML model (e.g., incident model 452, damage model 454, severity model 456, or ranking model 458, respectively). At block 808B, the risk application engine 482, optionally, applies the second climate event score to the property.

FIG. 8B is a flowchart of an example method for using climate event model on a property to generate a result in accordance with some implementations. In some implementations, blocks 820-826 are performed during training 602, and blocks 802-808 describe utilization 604b of the model. At block 820, the incident trainer 434 trains a climate event incident model 452. At block 822, the damage trainer 436 trains a climate event damage model.454. Optionally, at block 824, the severity trainer 438 trains a climate event severity model 456. Optionally, at block 826, the ranking trainer 440 trains a ranking model.

At block 802, the climate event scorer 462 receives a location of a property. At block 804, the risk scorer 462obtains property data associated with the property. At block 806A, the climate event scorer 462 determines an incident score using an incident model 452. At block 806B, the climate event scorer 462 determines a damage score using a damage model 454. Optionally, at block 806C, the climate event scorer 462 determines a severity score using a severity model 456. Optionally, at block 806D, the climate event scorer 462 determines a ranking score using a ranking model 458. Optionally, at block 807, the climate event trainer 422 determines a combined climate event score based on a combination of the incident, damage, severity, and ranking score or a combination of a subset thereof. Optionally, at block 808, the risk application engine 482 applies the climate event score(s) to the property.

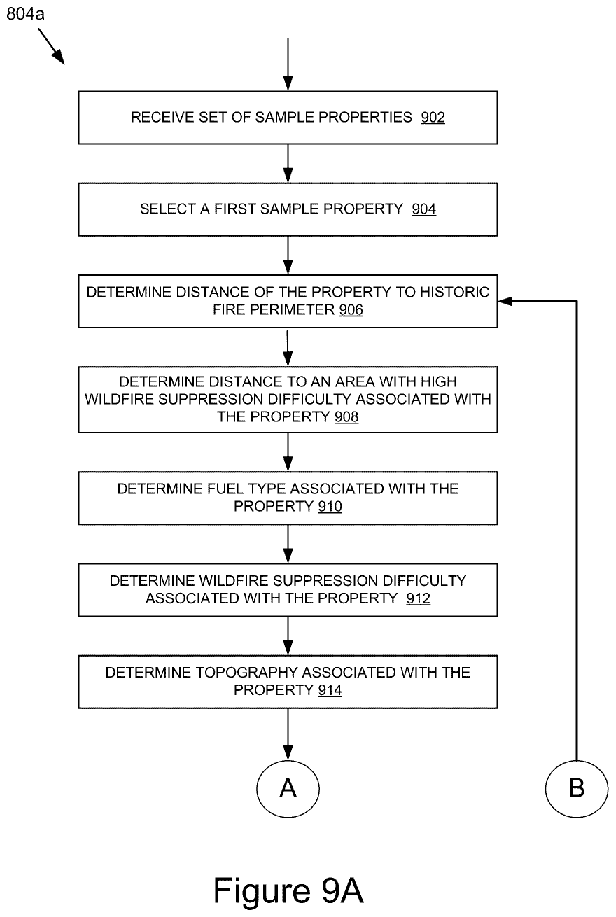

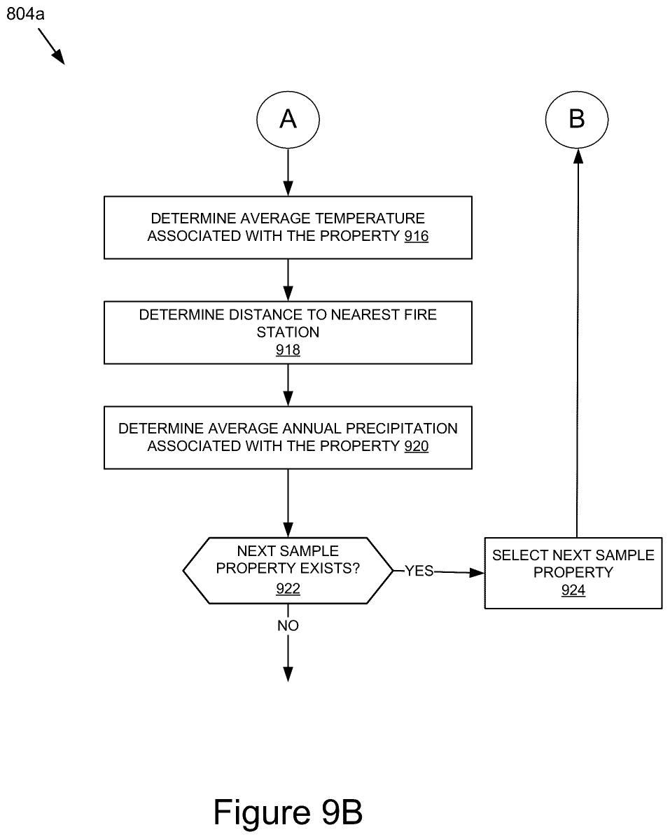

FIGS. 9A-B are a flowchart of an example method 804a for obtaining property data for determining an incident score for a wildfire in accordance with some implementations. It should be understood that, while described here as an example of obtaining the property data at 804 during utilization 604, as described in FIG. 8B, blocks similar, or identical, to blocks 902-924 may be performed during training 602 to obtain data for variables on which a model, the incident model 452 for wildfire in the case of FIGS. 9A-B, is trained.

At block 902, the incident scorer 472 receives a set of sample properties and selects a first sample property at block 904. For example, the incident scorer 472 may receive a set of multiple properties (e.g., as a batch), at block 904, and select one from the batch, at block 904, for processing at blocks 906-920. In another example, the incident scorer 472 may receive a single property set, at block 904, and select that property, at block 904, for processing at blocks 906-920.

At block 906, the incident scorer 472 determines a distance of the selected property to a historic fire perimeter. At block 908, the incident scorer 472 determines a distance to an area with high wildfire suppression difficulty associated with the area. For example, the minimum distance between the selected property and an area with high wildfire suppression difficulty. At block 910, the incident scorer 472 determines a fuel type associated with the selected property. At block 912, the incident scorer 472 determines a wildfire suppression difficulty associated with the selected property. At block 914, the incident scorer 472 determines a topography associated with the selected property.

Continuing to FIG. 9B, at block 916, the incident scorer 472 determines an average temperature associated with the selected property. At block 918, the incident scorer 472 determines a distance from the selected property to the nearest fire station. At block 920, the incident scorer 472 determines an average annual precipitation associated with the property.

At block 922, the incident scorer 472 determines whether another property, as yet unselected and processed 906-920, exists in the set of sample properties. If another property exists 922-YES, the incident scorer 472 selects a next sample property, at block 924, and the method 804a continues at block 906, with the next selected property. If another property exists 922-NO, the method 804a concludes.

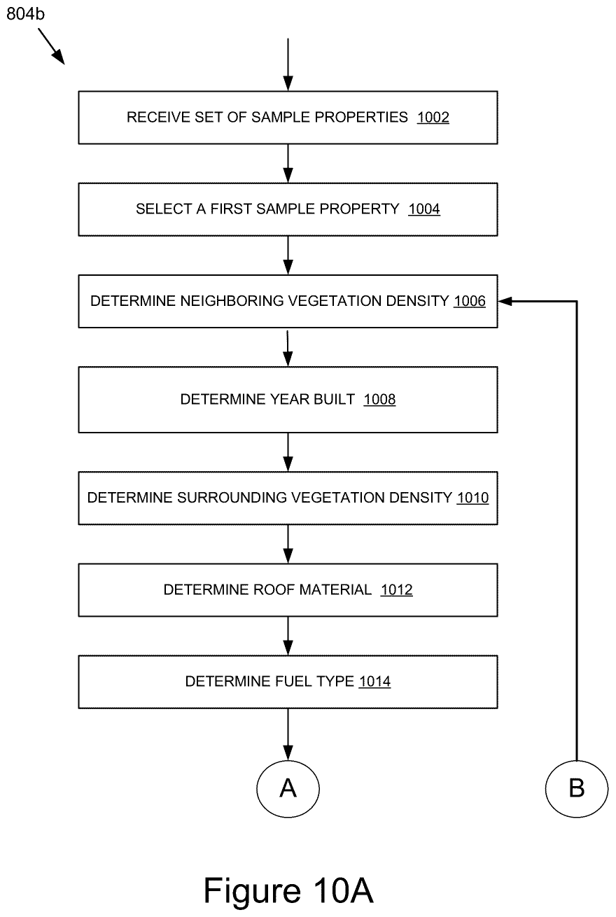

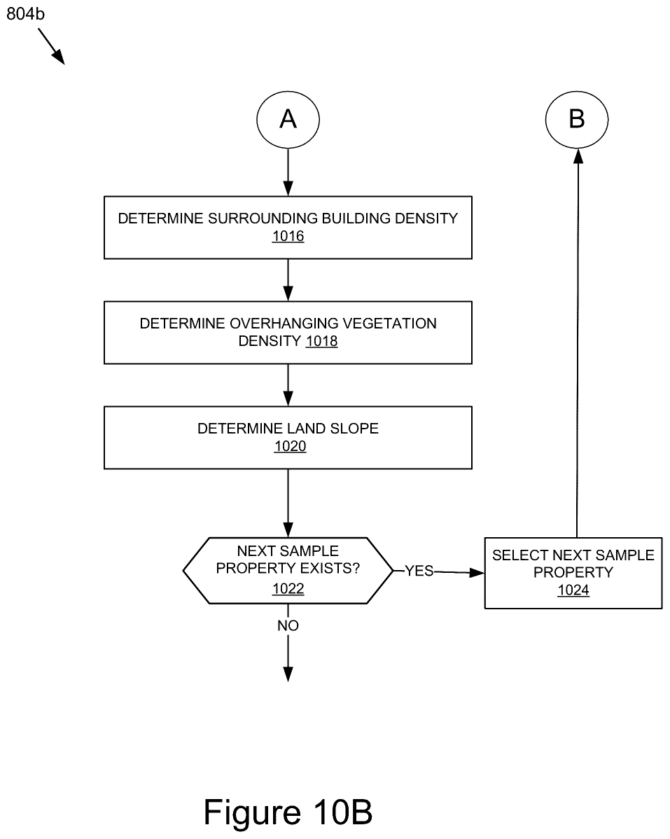

FIGS. 10A-B are a flowchart of an example method for obtaining property data for determining a damage score for wildfire in accordance with some implementations. It should be understood that, while described here as an example of obtaining the property data at 804 during utilization 604, as described in FIG. 8B, blocks similar, or identical, to blocks 1002-1024 may be performed during training 602 to obtain data for variables on which a model, the damage model 454 for wildfire in the case of FIGS. 10A-B, is trained.

At block 1002, the damage scorer 474 receives a set of sample properties and selects a first sample property at block 1004. For example, the damage scorer 474 may receive a set of multiple properties (e.g., as a batch), at block 1004, and select one from the batch, at block 1004, for processing at blocks 1006-1020. In another example, the damage scorer 474 may receive a single property set, at block 1004, and select that property, at block 1004, for processing at blocks 1006-1020.

At block 1006, the damage scorer 474 determines a neighboring vegetation density. At block 1008, the damage scorer 474 determines a build year associated with a structure on the property. At block 1010, the damage scorer 474 determines a surrounding vegetation density. At block 1012, the damage scorer 474 determines a roof material on a structure located on the property. At block 1014, the damage scorer 474 determines a fuel type associated with the selected property.

Continuing to FIG. 10B, at block 1016, the damage scorer 474 determines a surrounding building density. At block 918, the damage scorer 474 determines an overhanging vegetation density. At block 920, the damage scorer 474 determines a land slope associated with the property.

At block 1022, the damage scorer 474 determines whether another property, as yet unselected and processed 1006-1020, exists in the set of sample properties. If another property exists 1022-YES, the damage scorer 474 selects a next sample property, at block 1024, and the method 804b continues at block 1006, with the next selected property. If another property exists 1022-NO, the method 804b concludes.

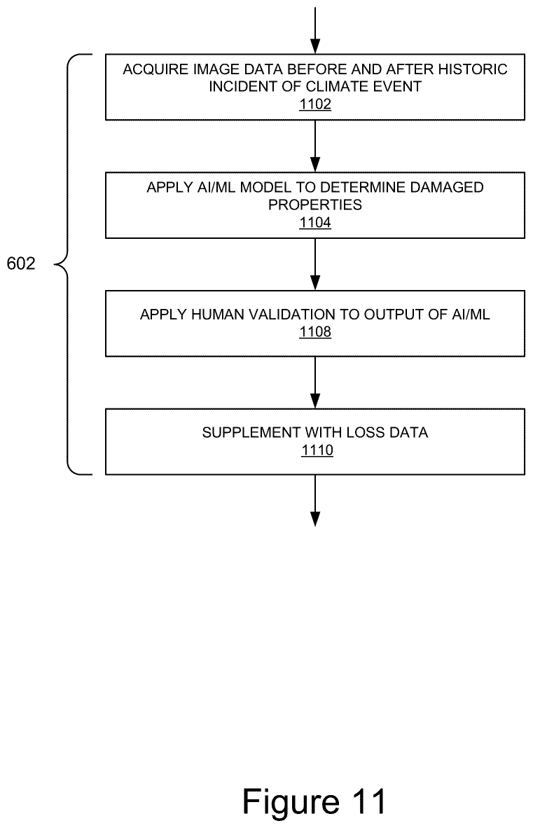

FIG. 11 is a flowchart of an example method for creating a dataset of structures damaged by a climate event including loss data in accordance with some implementations. In some implementations, the variable selector 502 acquires, at block 1102, image data from before and after historic incidents a climate event (e.g., satellite images before and after for all wildfires perimeters in the U.S. and Canada which contained buildings). At block 1104, the variable selector 502 applies an AI/ML model to determine damaged properties. For example, in some implementations, the variable selector 502 runs a neural network to identify which buildings were damaged or destroyed. At block 1106, the variable selector 502 applies human validation to the output (e.g., to validate whether the building was destroyed or not destroyed), and at block 1120, the variable selector 502 supplements the output with loss data.

### Example User Interfaces

FIGS. 12 and 13 example user interfaces associated with assessing a climate event in accordance with some implementations. FIGS. 12 and 13 are provided for illustrative purposes, and it should be understood that many variations exist and are within the scope of the disclosure herein.

FIG. 12 illustrates an example user interface 1200 associated with assessing a climate event in accordance with some implementations. In the illustrated implementation, a user interested in a set of climate event scores for wildfire can navigate to a website and the user interface 1200 is displayed. The user interface 1200 is associated with determining a climate event associated with wildfire, as indicated by “Z-FIRE” 1202. The user, in the illustrated example, is interested in the (wild) fire risk to street address “2821 ABC St., Anytown, CA 90210, USA.” As illustrated, only “2821” has been entered into search field 1204, and suggested property locations are generated and presented, below the search field 1204, in area 1206. In some implementations, the user interface 1200 is generated for presentation to a user 112 by a climate event scorer 462 of a fire risk engine 302a.

FIG. 13 illustrates another example user interface 1300 associated with assessing a climate event is illustrated in accordance with some implementations. User interface 1300 is associated with the risk of fire, as indicated by “Z-FIRE™” at 1302. Search filed 1304 indicates that a user provided the property location in the form of an address, i.e., “2821 ABC St., Anytown, CA 90210, USA.” At 1306, an indicator of the systems confidence in the one or more scores is provide, i.e., “High Confidence” in the illustrated implementation.

Portion 1312 of the user interface 1300 is associated with the level 1 score 1322 of the property identified in field 1304. The level 1 score is a “1/10” as indicated at 1324 and illustrated by the short, and color-coded bar in portion 1326. At 1328, a human readable summary of the factors decreasing the level 1 risk at the property is presented. The top features 1330 are also presented. Each top feature is presented as an identification of the variable and the value of that variable. For example, the “Landcover Class” 1332a at the property is “developed, medium intensity” 1334a, the “Distance to Fire Station” 1332b is “1,611 meters” 1334b, and the “Distance to High Wildfire Hazard Potential Area” 1332c is “10,728 meters” 1334c.

Portion 1314 of the user interface 1300 is associated with the level 2 score 1342 of the property identified in field 1304. The level 2 score is a “9/10” as indicated at 1344 and illustrated by the long, and color-coded bar in portion 1346. At 1348, a human readable summary of the factors increasing the level 2 risk at the property is presented. The top features 1350 are also presented. Each top feature is presented as an identification of the variable and the value of that variable. For example, the “Year Built” 1352a is “1924” 1354a, the “Building Density Zone 1” 1352b is “15%” 1354b, and the “Vegetation Density Zone 2” 1352c is “1%” 1354c.

Portion 1316 of user interface 1300 includes a satellite image with an indicator 1306 identifying the property in the image. In some implementations, the image shown at 1316 may have been used to generate one or more variables used to generate the score 1324 and/or 1344 for the property.

In some implementations, the user interface 1300 is generated for presentation to a user 112 by a climate event scorer 462 of a fire risk engine 302a. For example, an incident scorer 472 generates the level score and associated graphic elements 1324 and 1326, a damage scorer 474 generates the level 2 score and associated graphic elements 1344 and 1346, and a variable ranker 478 generates the top features for level 1 and level 2 and generates the text associated with the top features for level 1 and level 2, as indicated by 1332a-c, 1334a-c, 1352a-c, and 1354a-c, for presentation to the user.

### Other Considerations

It should be understood that the above-described examples are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

Reference in the specification to “one implementation” or “an implementation” or “some implementations” means that a particular feature, structure, or characteristic described in connection with the implementation is included in at least one implementation. The appearances of the phrase “in some implementations” in various places in the specification are not necessarily all referring to the same implementations.

In some instances, various implementations may be presented herein in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic optical disks, read-only memories (ROMs), random access memories (RAMs), EPROMS, EEPROMs, magnetic or optical cards, or any type of media suitable for storing electronic instructions, each coupled to a computer system bus.

The disclosure can take the form of an entirely hardware implementation, an entirely software implementation or an implementation containing both hardware and software elements. In a preferred implementation, the disclosure is implemented in software, which includes but is not limited to firmware, resident software, microcode, etc.

Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a flash memory, a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. for determining climate event using artificial intelligence. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is described with reference to a particular programming language. It will be appreciated that a variety of programming languages may be used to implement the teachings of the disclosure as described herein.

What is claimed is:

1. A method comprising:
generating, using one or more processors, a graphical user interface, wherein the graphical user interface includes:
a first portion associated with a location of a property of interest input by a user;
a second portion associated with an image of the property of interest;
a third portion associated with a climate event incidence score representing a relative probability of a first type of climate event occurring at the property of interest;
a fourth portion associated with a climate event damage score representing a relative severity of damage to the property of interest were the first type of climate event to occur at the property of interest; and
sending, using one or more processors, the graphical user interface for presentation to the user.

2. The method of claim 1, wherein the third portion includes one or more sub-portions indicating a first set of top features associated with the property of interest, wherein the first set of top features include a first set of features associated with the property of interest with a greatest relative impact on the climate event incidence score.

3. The method of claim 1, wherein the fourth portion includes one or more sub-portions indicating a second set of top features associated with the property of interest, wherein the second set of top features include a second set of features associated with the property of interest with a greatest relative impact on the climate event damage score.

4. The method of claim 1, wherein the graphical user interface further comprises one or more of:
a fifth portion associated with a confidence level; and
a sixth portion associated with one or more remedial actions that, when performed, may affect one or more of the climate event incidence score and the climate event damage score.

5. The method of claim 1 comprising:
receiving the location of the property of interest;
obtaining property data associated with the property of interest, wherein the property data includes image data associated with the property of interest;
determining, using a first climate associated with the first type of climate event, the climate event incidence score associated with the property; and
determining, using a second climate, the climate event damage score associated with the property of interest.

6. The method of claim 5, the method further comprising:
obtaining image data of a plurality of properties; and
automatically extracting, using computer vision, one or more features associated with the plurality of properties; and
training the first climate, wherein training the first climate based at least in part on the one or more features associated with the plurality of properties; and
validating the first climate based on one or more of a geographic location hold-out and a temporal hold-out, wherein the geographic location hold-out held out a geographic location including a location associated with the property.

7. The method of claim 6, wherein validation of the first climate is based on the temporal hold-out, the method further comprising:
determining whether the first climate is predictive of held-out data associated with a first time period of time, wherein the first climate is trained on a second time period distinct from the first time period associated with the held-out data;
iteratively training and validating the first climate with different temporal hold-outs to determine, based on an accuracy of the first climate:
a minimum period of most recent training data; and
a maximum period of most recent training data, wherein one or more of the minimum period and the maximum period of most recent training data are associated with a pattern change.

8. The method of claim 6, wherein a set of validation metrics is used to validate against a held-out population, the set of validation metrics including one or more of:
a sum of a target divided by a sum observed by the first climate;
an F1 score; and
a receiver operating characteristic,
wherein the F1 score and the receiver operating characteristic are indicative of an ability of the first climate to discriminate between areas likely to have an incident of the first climate event or not; and
wherein the first climate is adapted based on a bias associated with the first climate.

9. The method of claim 5, the method further comprising:
obtaining property image data associated with a plurality of properties, wherein the property image data associated with the plurality of properties includes images associated with the plurality of the properties visually representing at least a subset of the plurality of properties before and after a prior incident of the first climate event;
automatically extracting, using computer vision, one or more features associated with the plurality of properties; and
training the second climate, wherein training the second climate is based at least in part on the one or more features associated with the plurality of properties; and
validating the second climate based on one or more of a geographic location hold-out and a temporal hold-out, wherein the geographic location hold-out held out a geographic location including a location associated with the property.

10. The method of claim 9, wherein the validation is based on the temporal hold-out and further comprise one or more of:
determining whether the second climate is predictive of held-out data associated with a first time period of time, wherein the second climate is trained on a second time period distinct from the first time period associated with the held-out data; and
iteratively training and validating the second climate with different temporal hold-outs to determine, based on an accuracy of the second climate:
a minimum period of most recent training data; and
a maximum period of most recent training data, wherein one or more of the minimum period and the maximum period of most recent training data are associated with a pattern change.

11. The method of claim 9, wherein a set of validation metrics including one or more of:
a sum of a target divided by a sum observed by the second climate;
an F1 score; and
a receiver operating characteristic,
wherein the F1 score and the receiver operating characteristic are indicative of an ability of the second climate to discriminate between structures likely to be damaged or not, and
wherein the second climate is adapted based on a bias associated with the second climate

12. The method of claim 1, wherein first climate event is one of a wildfire, a flood, hail, lightning, tornado, hurricane, drought, and wind.

13. The method of claim 1, wherein:
the first climate event includes wildfire;
the climate event incidence score representing a likelihood of wildfire occurring at the location of the property;
the climate event damage score representing a likelihood of damage from wildfire to the property;
the incidence score is based on a first set of features including: a distance or the property to a historic fire perimeter, a distance of the property to an area with high wildfire suppression difficulty, a fuel type associated with the property, a wildfire suppression difficulty associated with the property, a topography associated with the property, an average temperature associated with the property, a distance of the property to a nearest fire station, and an average annual precipitation associated with the property; and
the climate event damage score is based on a second set of features including: a neighboring vegetation density, a year built, a surrounding vegetation density, a roof material associated with the property, a fuel type, the fuel type associated with the property, an overhanging vegetation density, and a land slope.

14. A system comprising:
a processor; and
a memory, the memory storing instructions that, when executed by the processor, cause the system to:
generate a graphical user interface, wherein the graphical user interface includes:
a first portion associated with a location of a property of interest input by a user;
a second portion associated with an image of the property of interest;
a third portion associated with a climate event incidence score representing a relative probability of a first type of climate event occurring at the property of interest;
a fourth portion associated with a climate event damage score representing a relative severity of damage to the property of interest were the first type of climate event to occur at the property of interest; and
send the graphical user interface for presentation to the user.

15. The system of claim 14, wherein the third portion includes one or more sub-portions indicating a first set of top features associated with the property of interest, wherein the first set of top features include a first set of features associated with the property of interest with a greatest relative impact on the climate event incidence score.

16. The system of claim 14, wherein the fourth portion includes one or more sub-portions indicating a second set of top features associated with the property of interest, wherein the second set of top features include a second set of features associated with the property of interest with a greatest relative impact on the climate event damage score.

17. The system of claim 14, wherein the graphical user interface further comprises one or more of:
a fifth portion associated with a confidence level; and
a sixth portion associated with one or more remedial actions that, when performed, may affect one or more of the climate event incidence score and the climate event damage score.

18. The system of claim 14, wherein the memory comprises instructions that, when executed by the processor, cause the system to:
receive the location of the property of interest;
obtain property data associated with the property of interest, wherein the property data includes image data associated with the property of interest;
determine, using a first climate associated with the first type of climate event, the climate event incidence score associated with the property; and
determine, using a second climate, the climate event damage score associated with the property of interest.

19. The system of claim 18, wherein the memory comprises instructions that, when executed by the processor, cause the system to:
obtain image data of a plurality of properties; and
automatically extract, using computer vision, one or more features associated with the plurality of properties; and
train the first climate, wherein training the first climate based at least in part on the one or more features associated with the plurality of properties; and
validate the first climate based on one or more of a geographic location hold-out and a temporal hold-out, wherein the geographic location hold-out held out a geographic location including a location associated with the property.

20. The system of claim 14, wherein first climate event is one of a wildfire, a flood, hail, lightning, tornado, hurricane, drought, and wind.
